(19) United States
(12) Patent Application Publication
(10) Pub. No.: US 2013/0271713 A1
(43) Pub. Date: Oct. 17, 2013

(54) LIQUID CRYSTAL DISPLAY DEVICE AND METHOD FOR MANUFACTURING LIQUID CRYSTAL DISPLAY DEVICE

(71) Applicants: Isamu Miyake, Osaka-shi (JP); Koichi Miyachi, Osaka-shi (JP); Tatsuro Kato, Osaka-shi (JP); Masakazu Shibasaki, Osaka-shi (JP); Masahiro Shimizu, Osaka-shi (JP); Kazuhito Matsumoto, Osaka-shi (JP)

(72) Inventors: Isamu Miyake, Osaka-shi (JP); Koichi Miyachi, Osaka-shi (JP); Tatsuro Kato, Osaka-shi (JP); Masakazu Shibasaki, Osaka-shi (JP); Masahiro Shimizu, Osaka-shi (JP); Kazuhito Matsumoto, Osaka-shi (JP)

(73) Assignee: SHARP KABUSHIKI KAISHA, Osaka-shi, Osaka (JP)

(21) Appl. No.: 13/879,447

(22) PCT Filed: Oct. 14, 2011
(86) PCT No.: PCT/JP2011/073599

§ 371 Date: May 23, 2013

(30) Foreign Application Priority Data
Oct. 14, 2010 (JP) 2010-231924
Apr. 6, 2011 (JP) 2011-084755
Aug. 25, 2011 (JP) 2011-183796

(51) Int. Cl. G02F 1/1337

(52) U.S. Cl. CPC G02F 1/133711; G02F 1/133788
USPC 349/124

(57) ABSTRACT

According to the present invention, provided is a liquid crystal display device in which a polymer layer having a stable alignment regulating force is formed. The liquid crystal display device according to the present invention includes a liquid crystal cell that includes a pair of substrates and a liquid crystal layer which is held between the pair of substrates, in which at least one substrate of the pair of substrates includes an electrode, an undercoat film which is formed on a liquid crystal layer side of the electrode, and a polymer layer which is formed on a liquid crystal layer side of the undercoat film and controls the alignment of liquid crystal molecules adjacent to the polymer layer, the undercoat film is formed of a photoactive material, the polymer layer is formed by polymerization of a monomer added to the liquid crystal layer, and the liquid crystal layer contains liquid crystal molecules having, in a molecular structure thereof, a multiple bond other than conjugated double bonds of a benzene ring.

### TECHNICAL FIELD

The present invention relates to a liquid crystal display device and a method for manufacturing a liquid crystal display device. More specifically, the present invention relates to a liquid crystal display device in which a polymer layer for improving properties is formed on an undercoat film such as an alignment film; and a method of manufacturing the liquid crystal display device.

### BACKGROUND ART

A liquid crystal display (LCD) device is a display device that controls the alignment of birefringent liquid crystal molecules to control the transmitting/shielding of light (on/off of display). Examples of a display method for LCD include the vertical alignment (VA) mode in which liquid crystal molecules having negative dielectric anisotropy are aligned perpendicular to a substrate surface; the in-plane switching (IPS) mode and the fringe field switching (FES) mode, in which liquid crystal molecules having positive or negative dielectric anisotropy are aligned parallel to a substrate surface to apply a horizontal electric field to a liquid crystal layer.

Among these, in the multi-domain vertical alignment (MVA) mode in which liquid crystal molecules having negative dielectric anisotropy are used and a rib or a slit of an electrode is provided as an alignment regulating structure, the liquid crystal alignment direction during voltage application can be controlled in plural directions without subjecting an alignment film to a rubbing treatment, and thus viewing angle characteristics are superior. However, in an MVA-LCD of the related art, an upper side of a rib or an upper side of a slit is the boundary of alignment division of liquid crystal molecules, the transmittance during white display is low, dark lines are observed in the display, and thus there is room for improvement.

Therefore, as a method for obtaining a high-luminance and high-speed response LCD, alignment stabilization methods using a polymer (hereinafter, also referred to as “polymer sustained (PS) method”) are disclosed (for example, refer to Patent Literatures 1 to 8). Among these, in pre-tilt angle imparting methods using a polymer (hereinafter, also referred to as “polymer sustained alignment (PSA) method”), polymerizable components such as polymerizable monomers and oligomers are mixed to obtain a liquid crystal composition; the liquid crystal composition is sealed between substrates; and the monomers are polymerized to form a polymer in a state where liquid crystal molecules are tilted by applying a voltage between the substrates. As a result, the liquid crystal molecules have a certain pre-tilt angle even after the voltage application is stopped, and thus the alignment direction of the liquid crystal molecules can be regulated to be uniform. The monomers are selected from materials which are polymerizable by heat, light (ultraviolet rays), or the like. In addition, the liquid crystal composition may contain a polymerization initiator for initiating the polymerization of monomers (for example, refer to Patent Literature 4).

Examples of other liquid crystal display elements using a polymerizable monomer include polymer dispersed liquid crystal (PDLC) and polymer network liquid crystal (PNLC) (for example, refer to Patent Literature 9). These elements include a polymer which is formed by adding a polymerizable monomer to liquid crystal and irradiating the mixture with ultraviolet rays or the like; and perform light scattering switching using the matching and non-matching of refractive indices between the liquid crystal and the polymer. In addition, examples of the other liquid crystal display elements include polymer-stabilized blue phase (for example, refer to Non Patent Literature 1 and Patent Literature 10), polymer-stabilized ferroelectric liquid crystal (FLC) phase (for example, refer to Patent Literature 11), and polymer-stabilized optically compensated bend (OCB) (for example, refer to Non Patent Literature 2).

Meanwhile, as a method for obtaining superior viewing angle characteristics, a photoalignment method is investigated in which the liquid crystal alignment direction during voltage application can be controlled in plural directions without subjecting an alignment film to a rubbing treatment and thus superior viewing angle characteristics can be obtained. The photoalignment method is a method in which a photoactive material is used to form an alignment film; and the formed film is irradiated with light rays such as ultraviolet rays to impart an alignment regulating force to the alignment film. As a result, a film surface can be subjected to an alignment treatment without contact. Therefore, the generation of impurities and dust can be suppressed during the alignment treatment, and thus the photoalignment method can be also applied to a large-sized panel unlike a rubbing treatment.

Recently, when the photoalignment method is used in combination with the polymer stabilization methods using a polymer, a research on a method of suppressing hysteresis has been disclosed (for example, refer to Non Patent Literature 3). Non Patent Literature 3 discloses a configuration of adjusting the concentration of a monomer which is mixed with liquid crystal in an IPS mode cell in which one substrate is subjected to a rubbing treatment and the other substrate is subjected to a photoalignment treatment.

### CITATION LIST

### Patent Literature

Patent Literature 1: Japanese Patent No. 4175826
Patent Literature 2: Japanese Patent No. 4237977
Patent Literature 3: JP-A-2005-181582
Patent Literature 4: JP-A-2004-286984
Patent Literature 5: JP-A-2009-102639
Patent Literature 6: JP-A-2009-132718
Patent Literature 7: JP-A-2010-33093
Patent Literature 8: U.S. Pat. No. 6,177,972
Patent Literature 9: JP-A-2004-70185
Patent Literature 10: JP-A-2006-348227
Patent Literature 11: JP-A-2007-92000

### Non Patent Literature

Non Patent Literature 1: H. Kikuchi, et al., Nature Materials, 1, pp. 64 to 68, 2002
Non Patent Literature 2: The Institute of Electronics, Information and Communication Engineers Technical Research Report, Vol. 95, (EID95-17), pp. 43 to 48, 1995
Non Patent Literature 3: Nagatake et al., Proceedings of The Japanese Liquid Crystal Society Annual Meetings 2010, “Reduction of EO Hysteresis of Photo-Aligned IPS-LCDs with Polymer Stabilized Method”, 2010. 9

### SUMMARY OF INVENTION

### Technical Problem

The current photoalignment method is usually introduced for mass-production of TVs using a vertical alignment film for the VA mode and the like; and has not yet been introduced for mass-production of TVs using a horizontal alignment film for the IPS mode and the like. The reason is that, when a horizontal alignment film is used, image sticking occurs to a large degree in liquid crystal display. Image sticking is the phenomenon in which, when the same voltage is applied to a part of liquid crystal cell for a given time and then the entire display is changed to another one, luminance appears to be different between portions to which a voltage is continuously applied and portions to which a voltage is not applied.

FIG. 12 is a diagram schematically illustrating a state of image sticking in a liquid crystal cell of the IPS mode which is manufactured by the present inventors performing a photoalignment treatment. As illustrated in FIG. 12, there is a large difference in luminance between a voltage (AC) application portion and a voltage (AC) non-application portion, and it is found that image sticking occurs to an extremely large degree in the voltage (AC) application portion. In order to reduce image sticking, it is necessary that a polymer layer be stably formed using the PS method. To that end, it is necessary that polymerization for the PS method be promoted.

The present invention has been made in consideration of such circumstances, and an object thereof is to provide a liquid crystal display device in which a polymer layer having a stable alignment regulating force is formed.

### Solution to Problem

Therefore, in order to prepare a liquid crystal cell of the IPS mode using a photoalignment treatment, the present inventors investigated the introduction of a polymer stabilization (PS) process of adding a polymerizable monomer to liquid crystal and polymerizing the polymerizable monomer with heat or light to form a polymer layer on the interface with a liquid crystal layer. FIG. 13 is a diagram schematically illustrating a state of image sticking in a liquid crystal cell of the IPS mode which is manufactured by the present inventors introducing a photoalignment treatment and adopting the PS process. As illustrated in FIG. 13, there is no difference in luminance between a voltage (AC) application portion and a voltage (AC) non-application portion, and it is found that image sticking is improved in the voltage (AC) application portion. As described above, by adding the PS process to a method of the related art, image sticking is significantly improved.

The present inventors have investigated in various ways the reason why image sticking occurs to a large degree particularly in a liquid crystal cell of the IPS mode, and have found that there is a difference in the mechanism of image sticking between a liquid crystal cell of the IPS mode and a liquid crystal cell of the VA mode. According to the investigation by the present inventors, in the VA mode, image sticking occurs because the tilt in a polar angle direction remains (is stored); whereas, in the IPS mode, image sticking occurs because the alignment in an azimuth direction remains (is stored) and an electric double layer is formed. In addition, according to further investigation, it was found that these phenomena are caused by a material used for a photoalignment film.

In addition, the present inventors have thoroughly investigated and found that the improvement caused by the PS process is particularly effective when an alignment film formed of a photoactive material is used. For example, it was found that, when an alignment film formed of a photoinactive material is subjected to a rubbing treatment or is not subjected any alignment treatment, the improvement caused by the PS process cannot be obtained.

According to the investigation by the present inventors, the reason why the combination of the alignment film formed of a photoactive material with the PS process is preferable is as follows. FIG. 14 is a diagram for comparison illustrating a polymerization state of a polymerizable monomer when an alignment film formed of a photoinactive material is subjected to the PS process, and FIG. 15 is a diagram for comparison illustrating a polymerization state of a polymerizable monomer when an alignment film formed of a photoactive material is subjected to the PS process. As illustrated in FIGS. 14 and 15, in the PS process, a pair of substrates and a liquid crystal composition with which a gap between the pair of substrates is filled are irradiated with light such as ultraviolet rays; the chain polymerization such as radical polymerization of polymerizable monomers 33 and 43 in a liquid crystal layer starts; and a polymer thereof is deposited on surfaces of alignment films 32 and 42 on the side of the liquid crystal layer 30 to form a polymer layer (hereinafter, also referred to as “PS layer”) for controlling the alignment of liquid crystal molecules.

When the alignment film is photoinactive, as illustrated in FIG. 14, polymerizable monomers 43a in the liquid crystal layer 30 which are excited by light irradiation are uniformly generated in the liquid crystal layer 30. Excited polymerizable monomers 43b are photopolymerized, and polymer layers are formed by phase separation on the interfaces between the alignment film 42 and the liquid crystal layer 30. That is, in the PS process, there is a process in which the polymerizable monomers 43b excited in the bulk are photopolymerized and move to the interfaces between the alignment film 42 and the liquid crystal layer 30.

On the other hand, when the alignment film 32 is photoactive, as illustrated in FIG. 15, a larger amount of polymerizable monomers 33b in the excited state are formed. The reason is that the alignment film 32 absorbs light when being irradiated with light and the excitation energy thereof is transferred to polymerizable monomers 33a. Due to this excitation energy, the polymerizable monomers 33a adjacent to the photoalignment film 32 are easily changed to the polymerizable monomers 33b in the excited state. That is, the polymerizable monomers 33a in the liquid crystal layer which are excited by light irradiation are concentrated on the vicinity of the interfaces between the alignment film 32 and the liquid crystal layer 30, and a large amount of the polymerizable monomers 33a are present thereon. Therefore, when the alignment film 32 is photoactive, a process in which the excited polymerizable monomers 33b are photopolymerized and move to the interfaces between the alignment film 32 and the liquid crystal layer 30 is negligible. Therefore, a polymerization rate and a rate of forming a polymer layer are improved, and thus a PS layer having a stable alignment regulating force can be formed.

In addition, as a result of investigation, the present inventors found that the image sticking reduction effect of the PS layer is particularly effective for a horizontal alignment film rather than a vertical alignment film. The reason is considered to be as follows. FIG. 16 is a diagram schematically illustrating a state of a vertical alignment film when polymerizable monomers are polymerized. FIG. 17 is a diagram schematically illustrating a state of a horizontal alignment film when polymerizable monomers are polymerized.

When an alignment film is a vertical alignment film as illustrated in FIG. 16, photoactive groups 52 included in the vertical alignment film are in indirect contact with liquid crystal molecules 54 and polymerizable monomers 53 through hydrophobic groups 55. Therefore, the transfer of the excitation energy from the photoactive groups 52 to the polymerizable monomers 53 is difficult.

On the other hand, when an alignment film is a horizontal alignment film as illustrated in FIG. 17, photoactive groups 62 included in the horizontal alignment film are in direct contact with liquid crystal molecules 64 and polymerizable monomers 63. Therefore, the transfer of the excitation energy from the photoactive groups 62 to the polymerizable monomers 63 is easy. Therefore, a polymerization rate and a rate of forming a polymer layer are improved, and thus a PS layer having a stable alignment regulating force can be formed.

Accordingly, when the PS process is performed in a case where an alignment film is formed of a photoactive material and the alignment film is a horizontal alignment film, the transfer of the excitation energy is significantly improved and image sticking can be reduced to a large degree.

As clearly seen from the above description, in order to increase a rate of forming a PS layer and to improve image sticking, the use of a photoactive material is important rather than a photoalignment treatment. In addition, regarding the transfer of the excitation energy between an alignment film and polymerizable monomers, photoexcitation is more important condition than photoisomerization and photocrosslinking which are the mechanisms of photoalignment.

In addition, as a result of additional thorough investigation, the present inventors found that the PS reaction can be promoted by adding a functional group having a multiple bond such as an alkenyl group to a molecular structure of a liquid crystal material. The reason is considered to be as follows. First, a multiple bond of liquid crystal molecules can be activated by light. Second, liquid crystal molecules can function as a carrier for transferring the activation energy, radicals, and the like. That is, it is considered that, when an undercoat film, which is an alignment film, is formed of a photoactive material and furthermore liquid crystal molecules are photoactive or function as a carrier for transferring radicals and the like, a polymerization rate of polymerizable monomers and a rate of forming a PS layer are improved and thus a PS layer having a stable alignment regulating force is formed.

In this way, the present inventors could solve the above-described problems, thereby completing the present invention.

That is, according to an aspect of the present invention, there is provided a liquid crystal display device including: a liquid crystal cell that includes a pair of substrates and a liquid crystal layer which is held between the pair of substrates, wherein at least one substrate of the pair of substrates includes an electrode, an undercoat film which is formed on a liquid crystal layer side of the electrode, and a polymer layer which is formed on a liquid crystal layer side of the undercoat film and controls the alignment of liquid crystal molecules adjacent to the polymer layer, the undercoat film is formed of a photoactive material, the polymer layer is formed by polymerization of a monomer added to the liquid crystal layer, and the liquid crystal layer contains liquid crystal molecules having, in a molecular structure thereof, a multiple bond other than conjugated double bonds of a benzene ring.

The configuration of the liquid crystal display device of the present invention is not especially limited as long as it essentially includes such components. The liquid crystal display device may or may not include other components. The following embodiments may be employed in combination. Preferable embodiments of the present invention include a combination of two or more embodiments among the following preferable embodiments of the present invention.

The pair of substrates included in the liquid crystal display device according to the present invention are substrates between which a liquid crystal layer is held; and is manufactured by, for example, forming a wiring, an electrode, a color filter, and the like on an insulating substrate formed of glass, resin, or the like.

At least one substrate of the pair of substrates included in the liquid crystal display device according to the present invention includes an electrode, an undercoat film which is formed on a liquid crystal layer side of the electrode, and a polymer layer which is formed on a liquid crystal layer side of the undercoat film and controls the alignment of liquid crystal molecules adjacent to the polymer layer. It is preferable that both substrates of the pair of substrates include the undercoat film. The undercoat film according to the present invention includes a film which is not subjected to an alignment treatment and thus does not have alignment properties, as well as an alignment film which has the property of aligning liquid crystal molecules adjacent thereto in a given direction. That is, the present invention is applicable to various processes such as a polymer stabilization process for widening a blue phase (BP) temperature range in a polymer-stabilized BP mode display device in which an alignment treatment is not necessary in the first place; a process for increasing the molecular weight of a part of a liquid crystal layer in a PDLC mode display device; a PSA process for forming a fine electrode pattern to fix the alignment or pre-tilt of liquid crystal using an electric field thereof; and a PS process for improving residual charge properties in an MVA mode or patterned vertical alignment (PVA) mode display device in which the alignment of liquid crystal is controlled by a rib and a slit. That is, in addition to the purpose of improving image sticking, the present invention is applicable to the applications which require forming a polymer from polymerizable monomers in a liquid crystal layer. When an alignment treatment is performed, examples of the alignment treatment include a rubbing treatment and a photoalignment treatment. From the viewpoint of obtaining superior viewing angle characteristics, the photoalignment treatment is preferable. However, an alignment treatment other than the photoalignment treatment, for example, the rubbing treatment may be used.

The undercoat film is formed of a photoactive material. By using a photoactive material as an undercoat film material, for example, when a monomer is photopolymerized, the undercoat film material is excited and the excitation energy or radicals are transferred to the monomer, thereby improving the reactivity of forming a PS layer. In addition, by irradiating light having specific conditions, a photoalignment treatment for imparting the alignment properties can be performed. Hereinafter, a polymer film having the property of controlling the alignment of liquid crystal through a photoalignment treatment will also be referred to as “photoalignment film”.

Examples of the photoactive material include photochromic compound materials, dye materials, fluorescent materials, phosphorescent materials, and photoalignment film materials. In addition, it is more preferable that the photoactive material contain at least one chemical structure selected from a group consisting of terphenyl derivatives, naphthalene derivatives, phenanthrene derivatives, tetracene derivatives, spiropyran derivatives, spiroperimidine derivatives, viologen derivatives, diarylethene derivatives, anthraquinone derivatives, azobenzene derivatives, cinnamoyl derivatives, chalcone derivatives, cinnamate derivatives, coumarin derivatives, stilbene derivatives, and anthracene derivatives. A benzene ring contained in these derivatives may be a heterocyclic ring. “Derivatives” described herein include compounds in which a part of an original chemical structure is substituted with a specific atom or a functional group; and compounds in which a monovalent or divalent or higher functional group is incorporated into a molecular structure. These derivatives may be present in a molecular structure of a main chain of a polymer or in a molecular structure of a side chain of a polymer; and may be a monomer or an oligomer. When a monomer or oligomer having such a photoactive functional group (preferably, 3% by weight or greater) is contained in the undercoat film material, a polymer forming the undercoat film may be photoinactive. As the polymer forming the undercoat film, polysiloxane, polyamic acid, or polyimide is preferable. In addition, the polymer forming the undercoat film may contain a cyclobutane skeleton.

As the photoactive material, the photoalignment film material is more preferable. The photoalignment film is a polymer film which has the properties of obtaining anisotropy and imparting an alignment regulating force to liquid crystal when being irradiated with polarized light or non-polarized light. The photoalignment film material may be a polymer alone or a mixture containing additional molecules as long as it has the above-described properties. For example, a low-molecular-weight compound such as an additive or a photoinactive polymer may further be added to a polymer having a photoalignable functional group. For example, an additive having a photoalignable functional group may be added to a photoinactive polymer. The photoalignment film material is selected from materials which cause photodegradation, photoisomerization or photodimerization. Normally, as compared to photodegradation, photoisomerization and photodimerization can perform alignment with light having a longer wavelength and a smaller irradiation amount and thus are superior in mass production. Representative examples of materials which cause photodegradation include materials which contain a compound having a cyclobutane skeleton.

That is, it is preferable that the material forming the photoalignment film contain a compound having either or both of a photoisomerizable functional group and a photodimerizable functional group. Representative examples of the materials which cause photoisomerization and photodimerization include azobenzene derivatives, cinnamoyl derivatives, chalcone derivatives, cinnamate derivatives, coumarin derivatives, diarylethene derivatives, stilbene derivatives, and anthracene derivatives.

In addition, it is more preferable that the photoisomerizable functional group or the photodimerizable functional group be a cinnamate group or a derivative thereof. These functional groups have particularly superior reactivity. A benzene ring contained in these derivatives may be a heterocyclic ring.

It is preferable that the undercoat film be a photoalignment film which is subjected to a photoalignment treatment by either or both of ultraviolet rays and visible light rays. Since the alignment is fixed by forming a PS layer, it is not necessary that ultraviolet rays or visible light rays are prevented from being incident on a liquid crystal layer after the manufacturing process, and thus the range of choice for the manufacturing process is widened. In addition, it is preferable that the undercoat film be a photoalignment film which is subjected to a photoalignment treatment by polarized light or non-polarized light. The degree of pre-tilt angle which is imparted to liquid crystal molecules by the photoalignment film can be adjusted by the kind of light, the irradiation time of light, the irradiation intensity of light, the kind of a photofunctional group.

The polymer layer is formed by polymerization of a monomer added to the liquid crystal layer and controls the alignment of liquid crystal molecules adjacent to the polymer layer. It is preferable that a polymerizable functional group of the monomer be an acrylate group, a methacrylate group, a vinyl group, a vinyloxy group, or an epoxy group. In particular, an acrylate group or a methacrylate group is preferable. An acrylate group or a methacrylate group has high radical production probability and is effective for cycle time reduction in manufacturing. In addition, it is preferable that the monomer be a monomer which starts polymerization (photopolymerization) by light irradiation or a monomer which starts polymerization (thermal polymerization) by heating.

That is, it is preferable that the polymer layer be formed by photopolymerization or be formed by thermal polymerization. In particular, photopolymerization is preferable because polymerization can be easily performed at room temperature. It is preferable that light used for the photopolymerization is either or both of ultraviolet rays and visible light rays. In addition, it is preferable that light used for the photopolymerization be non-polarized light or linearly polarized light. When the irradiation light is non-polarized light, an expensive member such as polarizing plate is not necessary. Therefore, exposure can be performed using an inexpensive device, which leads to a reduction in investment value for actual manufacturing. In addition, since the illuminance is high, there is an advantageous effect in that the cycle time can be reduced. On the other hand, in the case of irradiation of non-polarized light, there is a disadvantageous effect in that, for example, when a photoalignment film subjected to an alignment treatment is used, the alignment degree of the photoalignment film deteriorates and the contrast slightly deteriorates. Accordingly, when linearly polarized light is used for the photopolymerization, the alignment of a polymer can be improved and the contrast can be increased while maintaining the alignment degree of a photoalignment film. On the other hand, there is a disadvantageous effect in that an expensive member such as a polarizing plate is necessary for emitting linearly polarized light; and that the cycle time is increased because the illuminance is reduced to approximately half. Whether non-polarized light or linearly polarized light is used for the photopolymerization is appropriately selected based on the priority between the performance and the cost.

It is preferable that the number of polymerizable functional groups included in the monomer is more than or equal to 2. The more the number of polymerizable functional groups, the higher the reaction efficiency. Therefore, polymerization can be performed by light irradiation for a short period of time. However, the more the number of polymerizable functional groups, the greater the molecular weight. Therefore, it is difficult to dissolve the monomer in liquid crystal. In consideration of this point, it is more preferable that the number of polymerizable functional groups included in the monomer is less than or equal to 4.

In the present invention, polymerization for forming a PS layer is not particularly limited, and examples thereof include “step-growth polymerization” in which bifunctional monomers are polymerized stepwise while forming a new bond; and “chain polymerization” in which monomers are sequentially bonded to active species produced from a small amount of catalyst (for example, a polymerization initiator) and are grown in a chain reaction. Examples of the step-growth polymerization include polycondensation and polyaddition. Examples of the chain polymerization include radical polymerization and ionic polymerization (for example, anionic polymerization and cationic polymerization).

The polymer layer can be formed on the undercoat film subjected to an alignment treatment, that is, on an alignment film to improve the alignment regulating force of the alignment film. As a result, image sticking in display is significantly reduced and thus display quality can be significantly improved. In addition, when monomers are polymerized to form a polymer layer in a state where liquid crystal molecules are aligned at a pre-tilt angle by applying a threshold or higher voltage to a liquid crystal layer, the polymer layer are formed to have a structure in which liquid crystal molecules are aligned at a pre-tilt angle.

It is preferable that a concentration of the monomer, added to the liquid crystal layer, in the entire composition constituting the liquid crystal layer before polymerization be greater than or equal to 0.15% by weight. It is more preferable that the monomer concentration be greater than or equal to 0.2% by weight. As described below, according to the investigation by the present inventors, when the monomer concentration is less than 0.15% by weight, the effect of reducing image sticking in the PS process is small. On the other hand, when the monomer concentration is greater than or equal to 0.15% by weight and preferably greater than or equal to 0.2% by weight, the effect of reducing image sticking is significantly exhibited. When plural kinds of monomers are used, the monomer concentration is calculated based on the total amount of all the monomers.

It is preferable that a concentration of the monomer, added to the liquid crystal layer, in the entire composition constituting the liquid crystal layer before polymerization be less than or equal to 0.6% by weight. As described below, according to the investigation by the present inventors, when the monomer concentration is greater than or equal to 0.6% by weight, there are cases in which a slight amount of unreacted monomers in the PS process causes polymerization with panel inspection light, light emitted from an illumination, or the like; polymerization is further accelerated by applied heat or the like; a fine polymer is formed; and thus plural small luminous dots are generated in a pixel region. Alternatively, there are cases in which a polymer having an uneven thickness is formed by polymerization of a slight amount of unreacted monomers in the PS process; the alignment of liquid crystal is disordered to cause the leakage of light; and black display appears to be rough. These phenomena may cause deterioration in contrast ratio. When plural kinds of monomers are used, the monomer concentration is calculated based on the total amount of all the monomers.

It is preferable that the undercoat film be a horizontal alignment film which aligns liquid crystal molecules adjacent to the horizontal alignment film substantially parallel to a surface of the undercoat film. When the photoactive material is irradiated with light, the transfer of the excitation energy from the monomer to the alignment film is more effectively performed in a horizontal alignment film rather than in a vertical alignment film, thereby forming a PS layer more stably. Therefore, it is preferable that an alignment mode of the liquid crystal layer be the IPS mode, the FFS mode, the OCB mode, the twisted nematic (TN) mode, the super twisted nematic (STN) mode, the FLC mode, the PDLC mode, or the PNLC mode in which a horizontal alignment film can be used. In addition, the blue phase mode in which the formation of an alignment film is not necessary is also preferable. Among these, the IPS mode, the FFS mode, the FLC mode, the PDLC mode, or the blue phase mode is more preferable because the desired alignment can be achieved by one step of polarized light irradiation from a normal direction of a substrate and thus the process is simple and mass productivity is superior. In the OCB mode, the TN mode, and the STN mode, when pre-tilt is developed with a method described below in Examples, two steps of polarized light irradiation is necessary in which first irradiation of polarized light is performed from a normal direction of a substrate; and second irradiation of polarized light is performed from an oblique direction of the substrate, after rotated the plane of polarization of the polarized light from the angle at the first irradiation by 90°.

The FFS mode is more preferable. In the FFS mode, a plate-like electrode (solid electrode) is provided in addition to a comb electrode. Therefore, for example, when substrates are bonded using an electrostatic chuck, the solid electrode can be used as a blocking wall for preventing a high voltage from being applied to a liquid crystal layer, and thus the efficiency in the manufacturing process is particularly superior.

In the alignment mode, in order to improve viewing angle characteristics, it is preferable that at least one substrate of the pair of substrates has a multidomain structure. The multidomain structure refers to the structure in which there are plural regions having different alignment forms (for example, bend directions in the OCB mode or twist directions in the TN and STN mode) or different alignment directions of liquid crystal molecules during either or both voltage application and non-voltage application. In order to obtain a multidomain structure, it is necessary that either or both processes including a process of actively patterning an electrode into an appropriate form; and a process of irradiating a photoactive material with light using a photomask or the like be performed.

The undercoat film may be a photoalignment film which is irradiated with ultraviolet rays emitted from the outside of the liquid crystal cell. In this case, when the undercoat film is formed by a photoalignment treatment; and the polymer layer is formed by photopolymerization, it is preferable that the undercoat film and the polymer layer be simultaneously formed using the same light. As a result, a liquid crystal display device having high manufacturing efficiency is obtained.

It is preferable that the electrode be a transparent electrode. Examples of a material of the electrode include translucent materials such as indium tin oxide (ITO) and indium zinc oxide (IZO). For example, when one substrate of the pair of substrates has a color filter, it is necessary that the irradiation of ultraviolet rays for polymerizing the monomer be performed on the other substrate not having a color filter. Therefore, when the other electrode has a light-shielding electrode, the polymerization efficiency of the monomer is low.

It is preferable that at least one substrate of the pair of substrates further includes a planarizing film which planarizes a substrate surface. For example, when a TFT, a wiring, and the like are formed on an array substrate, a surface of the array substrate is uneven, which causes the alignment disorder of liquid crystal molecules, and thus deterioration in contrast ratio may easily occur. In addition, for example, on a color filter substrate, a surface of the color filter substrate is uneven depending on the presence of color filter, which causes the same problem. By providing the planarizing layer, the roughness and thickness nonuniformity of a layer below the planarizing layer can be solved, which contributes to the improvement of the contrast ratio. Therefore, for example, when the monomer concentration is greater than or equal to 0.6% by weight as described above, this configuration is particularly preferable. When the planarizing layer is used for a substrate on which an electrode is formed, it is necessary that the planarizing layer be formed below the electrode (opposite side to a liquid crystal layer side).

A liquid crystal layer included in the liquid crystal display device according to the present invention contains liquid crystal molecules having, in a molecular structure thereof, a multiple bond other than conjugated double bonds of a benzene ring. The liquid crystal molecules may have either positive dielectric anisotropy (positive type) or negative dielectric anisotropy (negative type). It is preferable that the liquid crystal molecules be nematic liquid crystal molecules having a high symmetric property in the liquid crystal layer. Examples of a skeleton of the liquid crystal molecules include a structure in which two ring structures and groups bonded to the ring structures are linearly bonded to each other.

The multiple bond does not contain conjugated double bonds of a benzene ring. This is because the benzene ring has low reactivity. The liquid crystal molecule according to the present invention may include conjugated double bonds of a benzene ring, that is, the conjugated double bonds be not excluded from it; as long as it has a multiple bond other than conjugated double bonds of a benzene ring. In addition, the liquid crystal molecules included in the liquid crystal layer according to the present invention may be a mixture of plural kinds thereof. In order to secure the reliability, to improve the response speed, and to adjust the liquid crystal phase temperature range, the elastic constant, the dielectric anisotropy, and the refractive index anisotropy, a liquid crystal material may be a mixture of plural kinds of liquid crystal molecules.

It is preferable that the multiple bond be a double bond, and it is more preferable that the double bond be contained in an ester group or an alkenyl group. As the multiple bond, a double bond has higher reactivity than that of a triple bond. The multiple bond may be a triple bond. In this case, it is preferable that the triple bond be contained in a cyano group. Furthermore, it is preferable that the liquid crystal molecules contain two or more kinds of multiple bonds.

It is preferable that the liquid crystal molecules have at least one molecular structure selected from a group consisting of structures represented by the following formulae (1-1) to (1-6). Among these, a molecular structure represented by the formula (1-4) is particularly preferable.

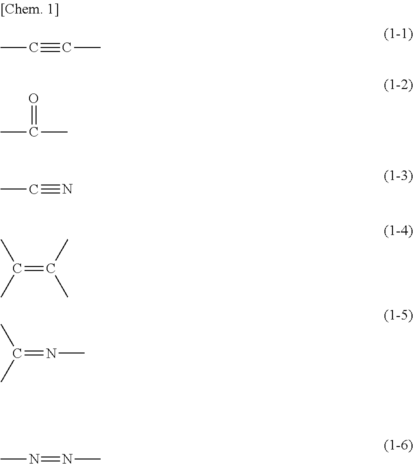

In addition, as a result of additional investigation from different perspectives, the present inventors focused on the fact that the alignment of a polymer is improved without using the above-described liquid crystal molecules when linearly polarized light is used for the photopolymerization; and found that deterioration in contrast ratio, which is likely to occur in the PS process, can be suppressed by the use of linearly polarized light.

That is, according to another aspect of the invention, there is provided a method for manufacturing a liquid crystal display device including: a step of forming a horizontal alignment film on at least one substrate of a pair of substrates; a step of filing a gap between the pair of substrates with a liquid crystal composition containing a monomer; and a step of irradiating the monomer with light to form a polymer layer on the horizontal alignment film, wherein the monomer is irradiated with linearly polarized light. “Linearly polarized light” described in this specification refers to light in which, when the light, as seen from a traveling direction thereof, is divided into two specific axis components (long axis and short axis components of an ellipse) of the electric field vector, and when the content of one component is 1, the content of the other component is 2 (that is, the content ratio is 2:1) or more. In this case, the content of the other component is preferably 5 (that is, the content ratio is 5:1) or more and more preferably 10 (that is, the content ratio is 10:1) or more.

It is preferable that the linearly polarized light with which the monomer is irradiated has a polarization direction substantially perpendicular to an alignment direction of liquid crystal molecules in the liquid crystal composition. When a part of liquid crystal molecules, deviated from an alignment direction, is irradiated with the linearly polarized light, the part of liquid crystal molecules is excited and is unstable in terms of energy because liquid crystal molecules generally have light absorption anisotropy. Thereby, the alignment degree of liquid crystal molecules during the PS process is temporarily increased and the liquid crystal molecules are aligned in an appropriate direction. Along with this, the alignment degree of a polymer is increased and the alignment of liquid crystal molecules is fixed. As a result, deterioration in contrast ratio can be suppressed and the effect of improving the contrast ratio can also be obtained depending on conditions. “Substantially perpendicular” described herein refers to the range of 90±5°.

It is preferable that the step of forming a horizontal alignment film includes a step of subjecting a photoalignment film material to a photoalignment treatment. As described above, by using the photoalignment film material, the undercoat film material is excited during the PS process and the excitation energy or radicals are transferred to the monomer. As a result, the reactivity of forming a PS layer can be improved.

It is preferable that the photoalignment treatment be performed using linearly polarized light; and that a polarization direction of the linearly polarized light with which the monomer is irradiated substantially match with a polarization direction of linearly polarized light used for the photoalignment treatment. In a case where the irradiation of linearly polarized light is performed as the photoalignment treatment, when light used for the PS process is non-polarized light (randomly polarized light), the alignment degree of the photoalignment film deteriorates. Therefore, in order to obtain the effect of the PS process while maintaining the alignment degree of the photoalignment film, it is preferable that linearly polarized light be irradiated. At this time, it is preferable that a polarization direction of the linearly polarized light with which the monomer is irradiated substantially match with a polarization direction of the linearly polarized light used for the photoalignment treatment. As a result, deterioration in contrast ratio can be suppressed and the effect of improving the contrast ratio can also be obtained depending on conditions. “Substantially match” described herein includes errors within the range of 5°.

It is preferable that the photoalignment film material contain a compound having either or both of a photoisomerizable functional group and a photodimerizable functional group, from the viewpoint of mass productivity. The photoalignment film material may contain a compound having a cyclobutane skeleton which causes photodegradation. It is more preferable that the photoisomerizable functional group or the photodimerizable functional group be a cinnamate group or a derivative thereof, from the viewpoint of obtaining extremely high reactivity.

It is preferable that the liquid crystal composition contain liquid crystal molecules having, in a molecular structure thereof, a multiple bond other than conjugated double bonds of a benzene ring. As a result, as described above, a PS layer having a stable alignment regulating force can be formed.

It is preferable that the multiple bond be a double bond. As described above, as the multiple bond, a double bond has higher reactivity than that of a triple bond. In addition, it is more preferable that the double bond be contained in an alkenyl group.

It is preferable that an alignment mode of the liquid crystal layer be the IPS mode or the FFS mode. The manufacturing method according to the present invention is particularly effective for a horizontal alignment film and is extremely suitable for the IPS mode and the FFS mode.

It is preferable that a polymerizable functional group of the monomer contain at least one of an acrylate group and a methacrylate group. As described above, these functional groups have high radical production probability and are effective for cycle time reduction in manufacturing.

### Advantageous Effects of Invention

According to the present invention, since the PS layer that controls the alignment of liquid crystal molecules is stably formed, a liquid crystal display device having a small amount of deterioration in display quality such as image sticking can be obtained.

### BRIEF DESCRIPTION OF DRAWINGS

FIG. 1 is a cross-sectional view schematically illustrating a liquid crystal display device according to Embodiment 1 before a PS polymerization process.

FIG. 2 is a cross-sectional view schematically illustrating the liquid crystal display device according to Embodiment 1 after the PS polymerization process.

FIG. 3 is a plan view schematically illustrating the electrode arrangement of the liquid crystal display device according to Embodiment 1 in the IPS mode.

FIG. 4 is a plan view schematically illustrating the electrode arrangement of the liquid crystal display device according to Embodiment 1 in the FFS mode.

FIG. 5 is a diagram schematically illustrating a case in which a planarizing layer is formed on a color filter substrate.

FIG. 6 is a plan view schematically illustrating a comb electrode substrate of Example 1.

FIG. 7 is a diagram schematically illustrating a state in which a pair of substrates are bonded using an electrostatic chuck.

FIG. 8 is a graph illustrating the relationship between the monomer concentrations of Examples 7 to 11 and the image sticking ratio (ΔT).

FIG. 9 is a graph illustrating the relationship between the monomer concentrations of Examples 12 to 17 and the contrast ratio.

FIG. 10 is a cross-sectional view schematically illustrating a liquid crystal display device according to Embodiment 2.

FIG. 11 is a diagram schematically illustrating a light irradiation state when the PS polymerization process is performed in Embodiment 2.

FIG. 12 is a diagram schematically illustrating a state of image sticking in a liquid crystal cell of the IPS mode which is manufactured by the present inventors performing a photoalignment treatment.

FIG. 13 is a diagram schematically illustrating a state of image sticking in a liquid crystal cell of the IPS mode which is manufactured by the present inventors introducing a photoalignment treatment and adopting the PS process.

FIG. 14 is a diagram for comparison illustrating a polymerization state of a polymerizable monomer when an alignment film formed of a photoinactive material is subjected to the PS process

FIG. 15 is a diagram for comparison illustrating a polymerization state of a polymerizable monomer when an alignment film formed of a photoactive material is subjected to the PS process.

FIG. 16 is a diagram schematically illustrating a state of a vertical alignment film when polymerizable monomers are polymerized.

FIG. 17 is a diagram schematically illustrating a state of a horizontal alignment film when polymerizable monomers are polymerized.

### DESCRIPTION OF EMBODIMENTS

The present invention will be mentioned in more detail referring to the drawings in the following embodiments, but is not limited to these embodiments.

### Embodiment 1

A liquid crystal display device according to Embodiment 1 is a display device including a liquid crystal cell; and is suitably used for a TV panel, a digital signage, a medical monitor, an electronic book, a PC monitor, a portable terminal panel, or the like.

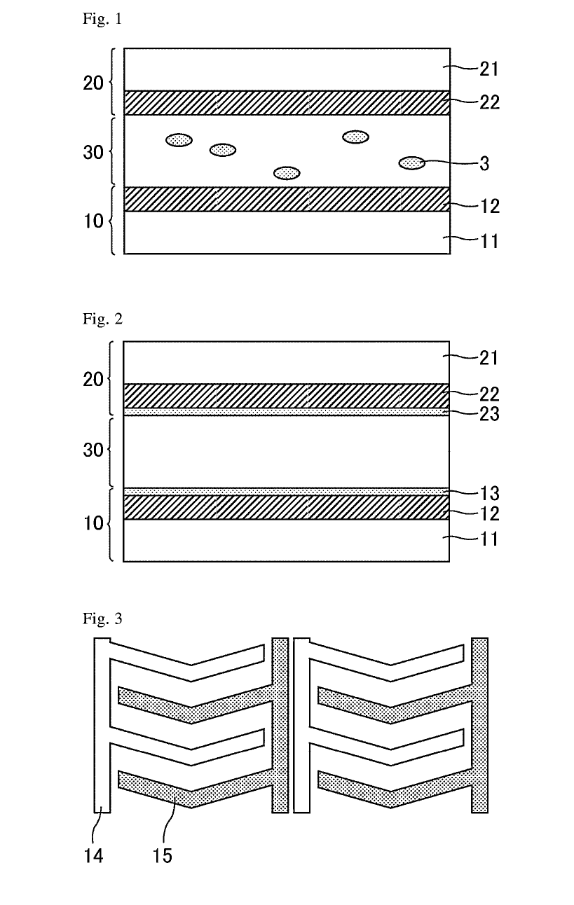

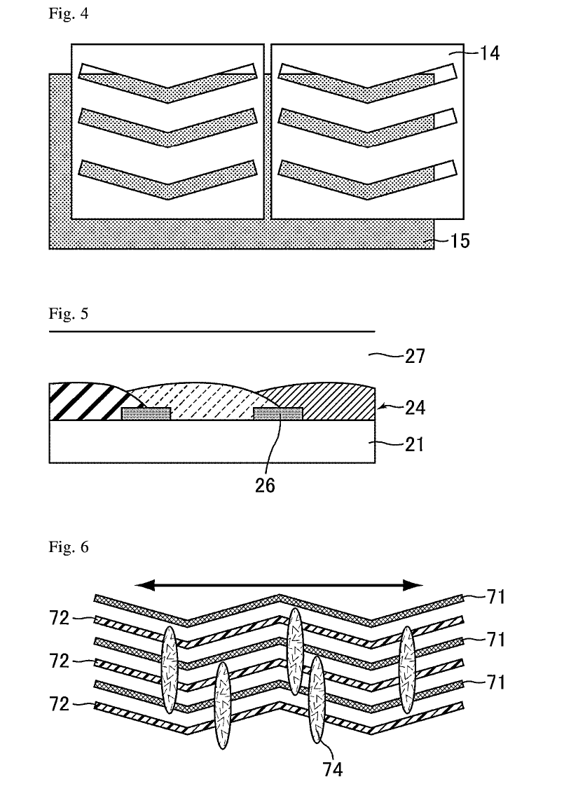

Hereinafter, the liquid crystal display device according to Embodiment 1 will be described in detail. FIGS. 1 and 2 are cross-sectional views illustrating the liquid crystal display device according to Embodiment 1. FIG. 1 illustrates the liquid crystal display device before a PS polymerization process, and FIG. 2 illustrates the liquid crystal display device after the PS polymerization process. As illustrated in FIGS. 1 and 2, the liquid crystal display device according to Embodiment 1 includes an array substrate 10, a color filter substrate 20, and a liquid crystal layer that is held between a pair of substrates including the array substrate 10 and the color filter substrate 20. The array substrate 10 includes an insulating transparent substrate 11 formed that is formed of glass or the like; and various kinds of wirings, signal electrodes, TFTs, and the like that are formed on the transparent substrate 11. The color filter substrate 20 includes an insulating transparent substrate 21 that is formed of glass or the like; and color filters, black matrixes, and a common electrode that are formed on the transparent substrate 21. For example, in the IPS or FFS mode, an electrode is formed on only the array substrate 10. However, in the other modes, as necessary, an electrode is formed on both the array substrate 10 and the color filter substrate 20. FIGS. 3 and 4 are plan views schematically illustrating the electrode arrangement of the liquid crystal display device according to Embodiment 1. FIG. 3 illustrates the IPS mode, and FIG. 4 illustrates the FFS mode. In the IPS mode, signal electrodes 14 and common electrodes 15 form a pair of comb electrodes and are alternately arranged to engage with each other in the same layer. In the FFS mode, one of the signal electrode 14 and the common electrode 15 is a comb electrode or a slit-provided electrode and the other is a plate-like electrode. In addition, the signal electrode 14 and the common electrode 15 are arranged in different layers through an insulating film. The signal electrode 14 and the common electrode 15 are transparent electrodes.

The array substrate 10 includes an alignment film (undercoat film) 12, and the color filter substrate also includes an alignment film (undercoat film) 22. The alignment films 12 and 22 are films containing polyimide, polyamide, polyvinyl, and polysiloxane as a major component. By providing the alignment film, liquid crystal molecules can be aligned in a given direction. The alignment films 12 and 22 are formed of a photoactive material. For example, a material which contains a compound having the above-described photoactive functional group is used.

As illustrated in FIG. 1, before the PS polymerization process, there are polymerizable monomers 3 in the liquid crystal layer 30. Through the PS polymerization process, the polymerization of the polymerizable monomers 3 starts. As illustrated in FIG. 2, PS layers 13 and 23 are formed on the alignment films 12 and 22, and thus the alignment regulating force of the alignment films 12 and 22 is improved. As the polymerizable monomers 3, a mixture of plural kinds of monomers may be used.

The PS layers 13 and 23 can be formed by injecting a liquid crystal composition containing a liquid crystal material and the polymerizable monomers into a gap between the array substrate 10 and the color filter substrate 20; and irradiating the liquid crystal layer 30 with a given amount of light or applying heat thereto to polymerize the polymerizable monomers 3. At this time, by performing the polymerization in a state where a threshold or higher voltage is applied to the liquid crystal layer 30, the PS layer 13 and 23 are formed in a shape following the initial tilt of liquid crystal molecules. Therefore, the PS layers 13 and 23 can be formed with higher alignment stability. As necessary, a polymerization initiator may be added to the liquid crystal composition.

It is preferable that the PS layers 13 and 23 be formed on the entire surfaces of the alignment films 12 and 22, and it is more preferable that the PS layers 13 and 23 having an approximately uniform thickness be densely formed. In addition, the PS layers 13 and 23 may be formed on the alignment films 12 and 22 in the form of plural points, that is, may be discretely formed on the surfaces of the alignment films 12 and 22. Even at this time, the alignment regulating force of the alignment films 12 and 22 can be uniformly maintained and image sticking can be suppressed. In this embodiment, in the liquid crystal layer 30, the PS layers 13 and 23 are formed on at least a part of the surfaces of the alignment films 12 and 22; and furthermore, a polymer-network structure may be formed on the entire liquid crystal layer 30 in the network form.

Examples of the polymerizable monomers 3 which can be used in Embodiment 1 include monomers which contain a monofunctional or polyfunctional polymerizable group having at least one kind of ring structure. Examples of such monomers include compound represented by the following formula (2).

[Chem. 2]

P¹—Sₚ¹—R²-A¹-(Z-A²)ₙ—R¹ (2)

(In the formula, R¹ represents a —R²-Sp¹-P¹ group, a hydrogen atom, a halogen atom, a —CN group, a NO₂ group, a —NCO group, a NCS group, a —OCN group, a —SCN group, a SF₅ group, or a linear or branched alkyl group having 1 to 12 carbon atoms;

P¹ represents a polymerizable group;

Sp¹ represents a linear, branched, or cyclic alkylene or alkyleneoxy group having 1 to 6 carbon atoms or a direct bond;

a hydrogen atom included in R¹ may be substituted with a fluorine atom or a chlorine atom;

as long as an oxygen atom and a sulfur atom are not adjacent to each other, a —CH₂— group included in R¹ may be substituted with an —O— group, an —S— group, an —NH— group, a —CO— group, a —COO— group, a —OCO— group, a —O—COO— group, a —OCH₂— group, a —CH₂O— group, a —SCH₂— group, a —CH₂S— group, an —N(CH₃)— group, an —N(C₂H₅)— group, an —N(C₃H₇)— group, an —N(C₄H₉)— group, a —CF₂O— group, an —OCF₂— group, a —CF₂S— group, an —SCF₂— group, a —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, or an —OCO—CH═CH— group.

R² represents an —O— group, an —S— group, an —NH— group, a —CO— group, a —COO— group, an —OCO— group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂O— group, an —OCF₂— group, a —CF₂S— group, an —SCF₂— group, an —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, an —OCO—CH═CH— group, or a direct bond;

A¹ and A² may be the same as or different from each other and each independently represent a 1,2-phenylene group, a 1,3-phenylene group, a 1,4-phenylene group, a naphthalene-1,4-diyl group, a naphthalene-1,5-diyl group, a naphthalene-2,6-diyl group, a 1,4-cyclohexylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, a 1,2,3,4-tetrahydronaphthalene-2,6-diyl group, an indane-1,3-diyl group, an indane-1,5-diyl group, an indane-2,5-diyl group, a phenanthrene-1,6-diyl group, a phenanthrene-1,8-diyl group, a phenanthrene-2,7-diyl group, a phenanthrene-3,6-diyl group, an anthracene-1,5-diyl group, an anthracene-1,8-diyl group, an anthracene-2,6-diyl group, or an anthracene-2,7-diyl group;

a —CH₂— group included in A¹ and A² may be substituted with an —O— group or an —S— group as long as they are not adjacent to each other;

a hydrogen atom included in A¹ and A² may be substituted with a fluorine atom, a chlorine atom, a —CN group, or an alkyl, alkoxy, alkylcarbonyl, alkoxycarbonyl, or alkylcarbonyloxy group having 1 to 6 carbon atoms;

each Z may be the same or different from one another and represents an —O— group, an —S— group, an —NH— group, a —CO— group, a —COO— group, an —COO— group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂O— group, an —OCF₂— group, a —CF₂S— group, an —SCF₂— group, an —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, an —OCO—CH═CH— group, or a direct bond; and

n represents 0, 1, or 2.)

Specific examples thereof include compound represented by the following formulae (3-1) to (3-5).

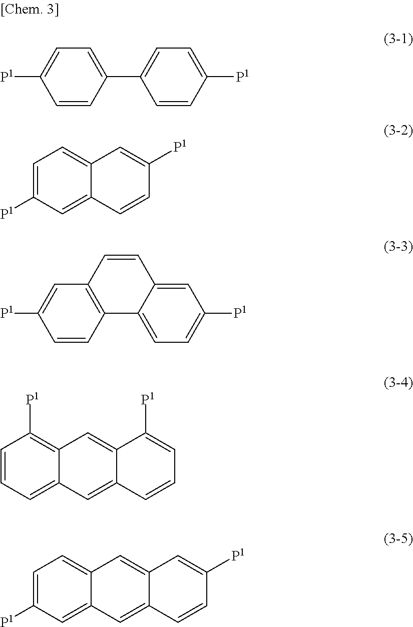

(In the formulae, each P¹ may be the same as or different from one another and represents a polymerizable group;

a part or all of the hydrogen atoms included in a benzene ring may be substituted with a halogen atom or an alkyl or alkoxy group having 1 to 12 carbon atoms; and

a part or all of the hydrogen atoms included in the alkyl or alkoxy group having 1 to 12 carbon atoms may be substituted with a halogen atom.)

The monomers represented by the formulae (3-1) to (3-5) are compounds which cause photofragmentation to generate radicals when being irradiated with ultraviolet rays. Therefore, the polymerization can be performed without a polymerization initiator and thus deterioration in display quality such as image sticking, caused by a residual polymerization initiator and the like after the PS process, can be prevented.

Examples of P¹ include an acryloyloxy group, a methacryloyloxy group, a vinyl group, a vinyloxy group, an acryloylamino group, and a methacryloylamino group.

Examples of other polymerizable monomers 3 which can be used in Embodiment 1 include compounds represented by the following formulae (4-1) to (4-8).

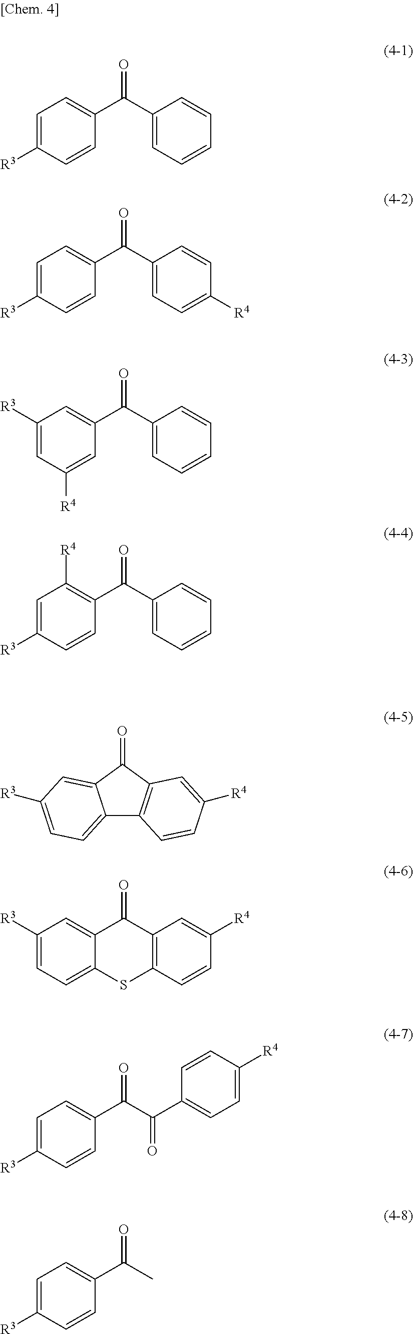

(In the formulae, R³ and R⁴ may be the same as or different from each other and each independently represent a -Sp²-P² group, a hydrogen atom, a halogen atom, a —CN group, an —NO₂ group, an —NCO group, an —NCS group, an —OCN group, an —SCN group, an —SF₅ group, or a linear or branched alkyl, aralkyl, phenyl group having 1 to 12 carbon atoms;

at least one of R³ and R⁴ includes an Sp²-P² group;

P² represents a polymerizable group;

Sp² represents a linear, branched, or cyclic alkylene or alkyleneoxy group having 1 to 6 carbon atoms, or a direct bond;

when at least one of R³ and R⁴ represents a linear or branched alkyl, aralkyl, phenyl group having 1 to 12 carbon atoms, a hydrogen atom included in at least one of R³ and R⁴ may be substituted with a fluorine atom, a chlorine atom, or a Sp²-P² group;

as long as an oxygen atom, a sulfur atom, and a nitrogen atom are not adjacent to each other, a —CH₂— group may be substituted with an —O— group, an —S— group, an —NH— group, a —CO— group, a —COO— group, an —COO— group, an —O—COO— group, an —OCH₂— group, a —CH₂O— group, an —SCH₂— group, a —CH₂S— group, an —N(CH₃)— group, an —N(C₂H₅)— group, an —N(C₃H₇)— group, an —N(C₄H₉)— group, a —CF₂O— group, an —OCF₂— group, a —CF₂S— group, an —SCF₂— group, an —N(CF₃)— group, a —CH₂CH₂— group, a —CF₂CH₂— group, a —CH₂CF₂— group, a —CF₂CF₂— group, a —CH═CH— group, a —CF═CF— group, a —C≡C— group, a —CH═CH—COO— group, or an —OCO—CH═CH— group;

a part or all of the hydrogen atoms included in a benzene ring may be substituted with a halogen atom or an alkyl or alkoxy group having 1 to 12 carbon atoms; and

a part or all of the hydrogen atoms included in the alkyl or alkoxy group having 1 to 12 carbon atoms may be substituted with a halogen atom.)

Examples of P² include an acryloyloxy group, a methacryloyloxy group, a vinyl group, a vinyloxy group, an acryloylamino group, and a methacryloylamino group.

The monomers represented by the formulae (4-1) to (4-8) are compounds in which hydrogen atoms are removed to generate radicals when being irradiated with visible light rays. Therefore, the polymerization can be performed without a polymerization initiator and thus deterioration in display quality such as image sticking, caused by a residual polymerization initiator and the like after the PS process, can be prevented.

In the liquid crystal display device according to Embodiment 1, the array substrate 10, the liquid crystal layer 30, and the color filter substrate 20 are laminated in this order from a back surface side to an observation surface side of the liquid crystal display device to form a liquid crystal cell. A linear polarizing plate is attached onto the back surface side of the array substrate 10 and the observation surface side of the color filter substrate 20. These polarizing plates may be provided with a retardation plate; and may be a circularly polarizing plate.

The liquid crystal display device according to Embodiment 1 may be any one of transmission type, reflection type, and transflective type devices. When the liquid crystal display device according to Embodiment 1 is a transmission type or transflective type device, a back light unit is further provided. The back light unit is arranged on the back surface side of the liquid crystal cell such that light passes through the array substrate 10, the liquid crystal layer 30, and the color filter substrate 20 in this order. When the liquid crystal display device according to Embodiment 1 is a reflection type or transflective type device, the array substrate 10 is provided with a reflector for reflecting outside electric field. In addition, at least in a region in which reflected light is used as display light, it is necessary that the polarizing plate of the color filter substrate 20 have a circularly polarized plate.

The liquid crystal display device according to Embodiment 1 may be a monochrome display device or a field sequential color type device. In this case, it is not necessary that a color filter be arranged.

When the array substrate includes a TFT, an oxide semiconductor having high mobility such as indium-gallium-zinc-oxide (IGZO) is preferable as a material of a semiconductor layer. By using IGZO, the size of a TFT element can be reduced as compared to a case of using amorphous silicon, which is suitable for a high-precision liquid crystal display. In particular, in a high-speed response type device such as a field sequential color type device, IGZO is preferably used.

It is preferable that the liquid crystal display device according to Embodiment 1 include a planarizing layer for planarizing the boundary surfaces between the respective substrates 10 and 20 and the liquid crystal layer 30. FIG. 5 is a diagram schematically illustrating a case in which the planarizing layer is formed on the color filter substrate. Black matrixes 26 and color filters 24 are respectively formed on the transparent substrate 21 in this order. Furthermore, an overcoat layer 27 is formed on the color filters 24. The overcoat layer 27 is the layer (planarizing layer) which is provided for planarizing an uneven surface generated by the shapes of the black matrixes 26 and the color filters 24; and is formed of, for example, an acrylate resin. The thickness of the overcoat layer 27 is preferably greater than or equal to 1 μm. By providing such a planarizing layer, the alignment disorder of liquid crystal molecules can be suppressed and deterioration in contrast ratio can be prevented.

The liquid crystal layer 30 is filled with a liquid crystal material having the property of being aligned in a specific direction by applying a given voltage thereto. The alignment of liquid crystal molecules in the liquid crystal layer 30 are controlled by the application of a threshold or higher voltage, and the liquid crystal molecules have, in a molecular structure thereof, a multiple bond other than conjugated double bonds of a benzene ring.

Examples of the liquid crystal molecules according to Embodiment 1 include liquid crystal molecules having, as a core portion, a structure in which two ring structures of at least one kind selected from a benzene ring, cyclohexylene, and cyclohexene are linked to a para position by a direct bond or a linking group; and a structure in which at least one kind selected from a hydrocarbon group having 1 to 30 carbon atoms and a cyano group is bonded to both sides (para position) of the core portion. The core portion may have a substituent and may have an unsaturated bond. Specific examples of the liquid crystal molecules include compounds represented by the following formulae (5) to (9). As a liquid crystal material, a material having plural kinds of such liquid crystal molecules is preferably used.

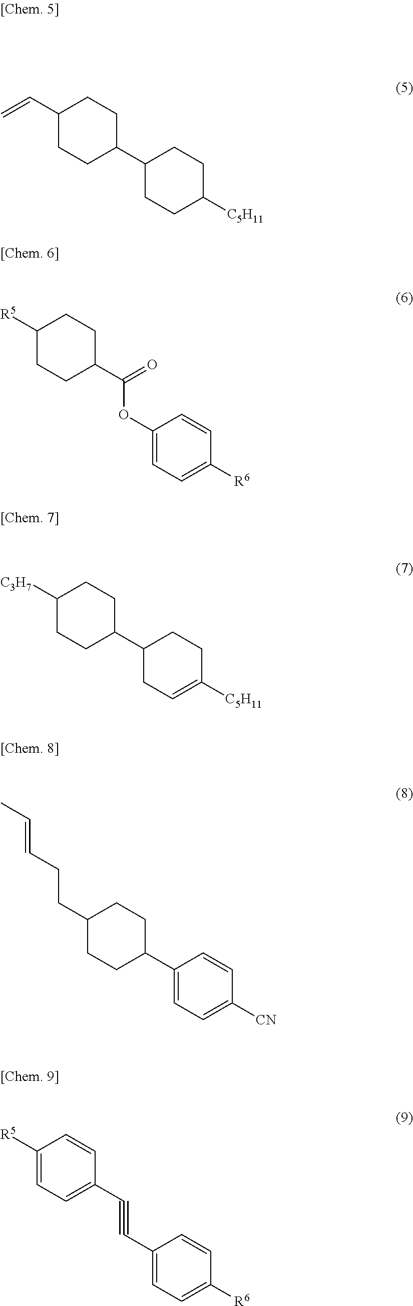

In the formulae (6) and (9), R⁵ and R⁶ may be the same as or different from each other and each independently represent a hydrocarbon group having 1 to 30 carbon atoms. The hydrocarbon group may have a substituent and may have an unsaturated bond.

In Embodiment 1, in the PS process, it is preferable that ultraviolet rays be irradiated from the side of the array substrate having an electrode. When ultraviolet rays are irradiated from the side of the counter substrate having color filters, the ultraviolet rays would be absorbed into the color filters.

Components of the alignment films, components of monomers included in the PS layers, and the like can be confirmed by dividing the liquid crystal display device according to Embodiment 1 and chemically analyzing the respective components using gas chromatograph mass spectrometry (GC-MS) and time-of-fright secondary ion mass spectrometry (TOF-SIMS). In addition, the cross-sectional shape of a liquid crystal cell including the alignment films and the PS layers can be confirmed using a scanning transmission electron microscope (STEM) and a scanning electron microscope (SEM).

Hereinafter, an example of actually preparing a liquid crystal cell included in the liquid crystal display device according to Embodiment 1 will be described.

### Example 1

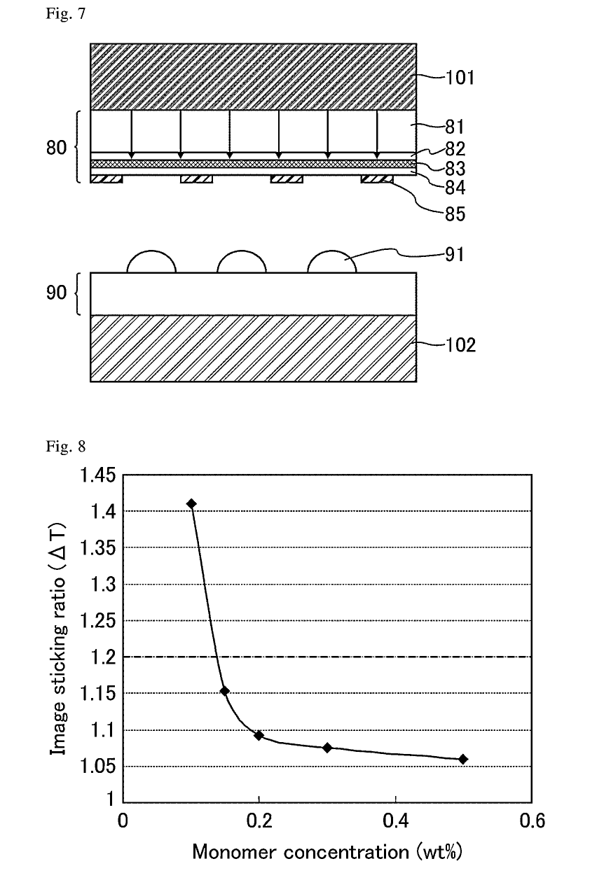

A glass substrate on which a pair of comb electrodes which are transparent electrodes are provided (hereinafter, the entire substrate will also be referred to as “comb electrode substrate”) and a blank glass substrate (counter substrate) were prepared. A polyvinyl cinnamate solution which was a material of a horizontal alignment film was coated on the respective substrates with a spin coating method. FIG. 6 is a plan view schematically illustrating the comb electrode substrate of Example 1. As the glass, #1737 (manufactured by Corning Inc.) was used. When the comb electrodes are schematically illustrated, as illustrated in FIG. 6, the common electrodes 71 and the signal electrodes 72 extend substantially parallel to each other and are respectively formed in a zigzag shape. As a result, since the electric field vector during electric field application is substantially perpendicular to a lengthwise direction of the electrodes, a multidomain structure is formed and thus superior viewing angle characteristics can be obtained. A double-headed arrow of FIG. 6 indicates an irradiation polarization direction (in a case where negative type liquid crystal molecules are used). As a material of the comb electrodes, IZO was used. In addition, the width L of the comb electrodes was 3 μm, and the distance S between the electrodes was 9 μm. The polyvinyl cinnamate solution was prepared by dissolving 3% by weight of polyvinyl cinnamate with respect to the total weight in a solvent obtained by mixing the same amount of N-methyl-2-pyrollidone and ethylene glycol monobutyl ether.

After coating with a spin coating method, provisional drying was performed at 90° C. for 1 minute, followed by burning at 200° C. for 60 minutes while purging nitrogen gas. The thickness of the alignment films after burning was 100 nm.

Next, as an alignment treatment, the surface of each substrate was irradiated with linearly polarized ultraviolet rays having a wavelength of 313 nm and an intensity of 5 J/cm² from the normal direction of each substrate. At this time, as illustrated in FIG. 6, an angle formed between the lengthwise direction of the comb electrodes and the polarization direction was set to ±15°. As a result, liquid crystal molecules 74 were aligned in a direction substantially perpendicular to the polarization direction of polarized ultraviolet rays during voltage non-application; and were aligned in a direction substantially perpendicular to the lengthwise direction of the comb electrodes during the application of a threshold or higher voltage.

Next, a thermosetting seal material (HC1413EP, manufactured by Mitsui Chemical Inc.) was printed on the comb electrode substrate using a screen plate. Furthermore, in order to obtain the liquid crystal layer having a thickness of 3.5 μm, beads (SP-2035, manufactured by Sekisui Chemical Co., Ltd.) having a diameter of 3.5 μm were dispersed on the counter substrate. These two kinds of substrates were aligned such that the polarization directions of ultraviolet rays irradiating the respective substrates match with each other, and then were bonded.

Next, the bonded substrates were heated in a furnace in which nitrogen gas was purged at 110° C. for 60 minutes while applying a pressure of 0.5 kgf/cm² thereto, and thereby the seal material was cured.

A liquid crystal composition containing a liquid crystal material and a monomer was injected into a cell prepared with the above-described method under vacuum. As the liquid crystal material, a negative type liquid crystal which contains liquid crystal molecules having a multiple bond other than a benzene ring was used. As the monomer, biphenyl-4,4′-diylbis(2-methyl acrylate) was used. The amount of biphenyl-4,4′-diylbis(2-methyl acrylate) added is 1% by weight with respect to the total weight of the entire liquid crystal composition.

A filling port through which the liquid crystal composition was injected was blocked with an ultraviolet ray-curable resin (TB3026E, manufactured by ThreeBond Co., Ltd.) and was sealed by irradiation of ultraviolet rays. The wavelength of ultraviolet rays irradiated for sealing was 365 nm, and light was blocked in pixel portions so as to remove the influence of ultraviolet rays as much as possible. At this time, electrodes were short-circuited and the charge of a surface of the glass substrate was eliminated such that the alignment of liquid crystal was not disordered by outside electric field.

Next, in order to remove the flow alignment of liquid crystal molecules, a realignment treatment of heating the liquid crystal cell at 130° C. for 40 minutes to make the liquid crystal molecules have isotropic phase was performed. As a result, a liquid crystal cell was obtained in which liquid crystal molecules were uniaxially aligned in the plane of the substrates in a direction perpendicular to the polarization direction of ultraviolet rays irradiating the alignment films.

Next, in order to subject this liquid crystal cell to the PS process, the liquid crystal cell was irradiated with non-polarized ultraviolet rays having an intensity of 2 J/cm² using a black light unit (FHF32BLB, manufactured by Toshiba Corporation). As a result, biphenyl-4,4′-diylbis(2-methyl acrylate) was polymerized.

The reaction systems (pathways of generating acrylate radicals) of the PS process in Example 1 are as follows.

### (Reaction System 1)

First, as illustrated in the following chemical reaction formula (11), biphenyl-4,4′-diylbis(2-methyl acrylate) (compound represented by the following formula (10); hereinafter, abbreviated as “M”) which is the monomer is excited by irradiation of ultraviolet rays to form radicals (hereinafter, the excited state will be indicated by the symbol *).

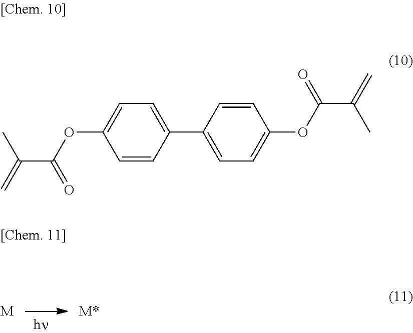

### (Reaction System 2)

Meanwhile, as illustrated in the following chemical reaction formula (13), polyvinyl cinnamate (compound represented by the following formula (12); hereinafter, abbreviated as “PVC”) which is the photoalignment film material is also excited by irradiation of ultraviolet rays.

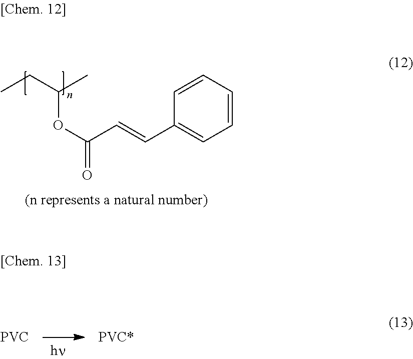

In addition, as illustrated in the following chemical reaction formula (14), biphenyl-4,4′-diylbis(2-methyl acrylate) which is the monomer is excited to form radicals by the energy transfer from excited polyvinyl cinnamate.

[Chem. 14]

M+PVC*→M*+PVC (14)

The reason why the reactivity of the PS process is improved is considered to be as follows. In the process of polymerizing biphenyl-4,4′-diylbis(2-methyl acrylate) which is the monomer with ultraviolet rays, it is considered that an intermediate such as a radical serves an important function. The intermediate is generated by ultraviolet rays, but the amount of the monomer in the liquid crystal composition is only 1% by weight. Therefore, sufficient polymerization efficiency is not obtained only with the pathway of the chemical reaction formula (11). When the PS process is performed only with the pathway of the chemical reaction formula (11), it is necessary that excited monomer intermediates be adjacent to each other in the liquid crystal bulk and thus the polymerization efficiency is low. In addition, since it is necessary that the monomer intermediates in which polymerization has already started move to the vicinity of the alignment films after the polymerization, the rate of the PS process is slow. In this case, it is considered that the rate of the PS process depends on the temperature and the diffusion coefficient.

However, when the photoalignment films are present, the photoalignment films contain a large amount of double bonds as a photofunctional group such as polyvinyl cinnamate of this example. Therefore, as illustrated in the chemical reaction formulae (13) and (14), it is considered that the photofunctional groups are easily excited by ultraviolet rays and the excitation energy is transferred to the monomer in liquid crystal. Furthermore, since this energy transfer occurs in the vicinity of the alignment films, the existence probability of the monomer intermediates in the vicinity of the alignment films is significantly increased, thereby remarkably increasing the polymerization probability and the rate of the PS process. Therefore, in this case, it is considered that the rate of the PS process barely depend on the temperature and the diffusion coefficient.

In addition, in the photoalignment films, electrons at a photoactive unit are excited. In addition, when the photoalignment films are horizontal alignment films, the photoactive unit directly interacts with the liquid crystal layer to align liquid crystal. Therefore, the intermolecular distance between a photoactive unit and polymerizable monomers is shorter than that of a vertical alignment film and thus the probability of the transfer of excitation energy is significantly increased. When the photoalignment films are a vertical alignment film, there is inevitably a hydrophobic group between a photoactive unit and polymerizable monomers. Therefore, the intermolecular distance is increased and the energy transfer is difficult to occur. Therefore, the PS process is particularly preferable for a horizontal alignment film.

When observed using a polarizing microscope, liquid crystal molecules in a photoaligned IPS cell (liquid crystal cell of Example 1), which was prepared with the above-described method and was subjected to the PS process, were uniaxially aligned in a favorable manner as was before the PS process. Furthermore, when liquid crystal was made to respond by applying a threshold or higher voltage thereto, the liquid crystal was aligned along zigzag-shaped comb electrodes and superior viewing characteristics were obtained by a multidomain structure.

Next, the liquid crystal cell of Example 1 was evaluated for image sticking. An evaluation method for image sticking is as follows. The liquid crystal cell of Example 1 was divided into regions X and Y to which two different voltages can be applied. A square wave voltage of 6 V and 30 Hz was applied to the region X and no voltage was applied to the region Y for 48 hours. Next, a square wave voltage of 2.4 V and 30 Hz was applied to the regions X and Y, respectively. Then, the luminance T(x) of the region X and the luminance T(y) of the region Y were measured, respectively. In order to measure the luminance, a digital camera (EOS Kiss Digital N EF-S18-55II U, manufactured by Canon Corporation) was used. A value ΔT(x,y) (%) which is the index of image sticking was calculated according to the following expression.

ΔT(x,y)=(|T(x)−T(y)|/T(y))×100

As a result of the calculation, the image sticking ratio ΔT of the liquid crystal cell of Example 1 was 24%.

As seen from Example 1, severe image sticking caused by a material of a photoalignment film can be significantly improved by performing the PS process without deterioration in alignment capability. Since image sticking is significantly improved, the irradiation amount (time) of ultraviolet rays can be reduced in the PS process. When a liquid crystal panel is manufactured, the irradiation amount (time) of ultraviolet rays is reduced and thus the throughput is increased. In addition, the size of an ultraviolet ray irradiation device can be reduced, which leads to a reduction in investment value.

### Comparative Example 1

An IPS liquid crystal cell of Comparative Example 1 was prepared with the same preparation method as that of Example 1, except that the monomer was not added to the liquid crystal composition; and the liquid crystal layer was not irradiated with ultraviolet rays using a black light unit.

As a result, the image sticking ratio was 800% or higher, and severe image sticking was observed.

That is, the only difference between the IPS liquid crystal cell of Comparative Example 1 and the IPS liquid crystal cell of Example 1 was whether the PS process was performed or not. Image sticking occurs due to the interaction between liquid crystal molecules and photoalignment film molecules. However, by forming the PS layer on the origin thereof as a buffer layer, image sticking can be prevented. It should be noted that image sticking caused by the photoalignment film can be significantly suppressed while liquid crystal molecules can be aligned by the alignment capability of the photoalignment film originating from the PS layer which is not subjected to an alignment treatment.

### Comparative Example 2

In Comparative Example 2, a positive type liquid crystal of 4-cyano-4′-pentylbiphenyl having a triple bond was used as a liquid crystal material; and the monomer was not added to the liquid crystal composition. In addition, as a photoalignment treatment, an angle formed between the lengthwise direction of the comb electrodes and the polarization direction of polarized ultraviolet rays was set to ±75°; and a black light unit was not used for the irradiation of ultraviolet rays. Except for the above-described points, an IPS liquid crystal cell was prepared with the same preparation method as that of Example 1.

As a result, the image sticking ratio was 800% or higher, and severe image sticking was observed.

### Example 2

An IPS liquid crystal cell was prepared with the same preparation method as that of Comparative Example 2, except that 1% by weight of biphenyl-4,4′diylbis(2-methyl acrylate), as the monomer, with respect to the total weight of the entire liquid crystal composition was added to the positive type liquid crystal of 4-cyano-4′-pentylbiphenyl. When observed using a polarizing microscope, liquid crystal molecules were uniaxially aligned in a favorable manner. Furthermore, when liquid crystal was made to respond by applying a threshold or higher voltage thereto, the liquid crystal was aligned along zigzag-shaped comb electrodes and superior viewing characteristics were obtained by a multidomain structure. In addition, the image sticking ratio was 11% when measured with the same method as that of Comparative Example 2, and a significant improvement effect was obtained.

The reaction systems (pathways of generating acrylate radicals) of the PS process in Example 2 are as follows.

### (Reaction System 1)

First, as illustrated in the following reaction chemical formula (15), biphenyl-4,4′-diylbis(2-methyl acrylate) which is the monomer is excited by irradiation of ultraviolet rays to form radicals.

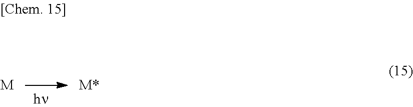

### (Reaction System 2)

Meanwhile, as illustrated in the following chemical reaction formula (16), polyvinyl cinnamate which is the photoalignment film material is also excited by irradiation of ultraviolet rays.

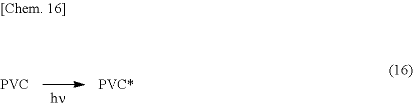

In addition, as illustrated in the following chemical reaction formula (17), biphenyl-4,4′-diylbis(2-methyl acrylate) which is the monomer is excited to form radicals by the energy transfer from excited polyvinyl cinnamate.

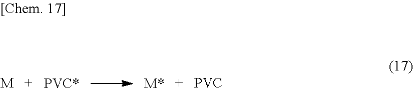

### (Reaction System 3)

Meanwhile, as illustrated in the following chemical reaction formula (19), 4-cyano-4′-pentylbiphenyl (compound represented by the following formula (18); hereinafter, abbreviated “CB”) which is the liquid crystal material having a triple bond in the molecules is also excited by irradiation of ultraviolet rays.

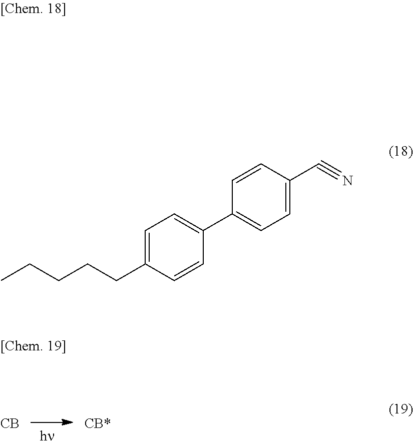 [SMILES: CCCCCc1ccc(-c2ccc(C#N)cc2)cc1 ; "CB" ; "CB*"]

In addition, as illustrated in the following chemical reaction formula (20), biphenyl-4,4′-diylbis(2-methyl acrylate) which is the monomer is excited to form radicals by the energy transfer from excited 4-cyano-4′-pentylbiphenyl.

[Chem. 20]

M+CB*→M*+CB (20)

### (Reaction System 4)

Meanwhile, as illustrated in the following chemical reaction formula (21), polyvinyl cinnamate which is the photoalignment film material is also excited by irradiation of ultraviolet rays.

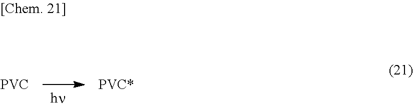

In addition, as illustrated in the following chemical reaction formula (22), a pathway is considered in which 4-cyano-4′-pentylbiphenyl which is the liquid crystal material having a triple bond in the molecules is excited by the energy transfer from excited polyvinyl cinnamate.

[Chem. 22]

CB+PVC*→CB*+PVC (22)

The difference between Example 2 and Example 1 is that the positive type liquid crystal of 4-cyano-4′-pentylbiphenyl was used as the liquid crystal material. When Example 1 and Example 2 are compared to each other, a higher improvement effect was obtained in Example 2. The reason is considered to be that the cyano group in the liquid crystal molecules contains a triple bond. A double bond of a benzene ring not having a substituent does not contribute to the reaction. Therefore, it can be concluded that the triple bond of the cyano group serves an important function.

In this way, when liquid crystal molecules have a multiple bond, image sticking is improved by the PS process. The reason is considered to be as follows. As illustrated in the chemical reaction formulae (13) and (14), the excited monomer intermediates of Example 1 are generated by ultraviolet rays and the energy transfer from the photoalignment films. However, since 4-cyano-4′-pentylbiphenyl contains the triple bond of the cyano group in the molecules, the liquid crystal molecules are excited by radicals and the like. In addition, it is considered that the PS process is promoted through, for example, pathways illustrated in the chemical reaction formulae (19) and (20) as well as the reaction systems illustrated in the chemical reaction formulae (13) and (14). Furthermore, as illustrated in the chemical reaction formulae (21) and (22), a pathway is also considered in which the energy is transferred from the excited photoalignment films to liquid crystal molecules and thus the liquid crystal molecules are excited. That is, since the monomer is excited through more pathways than that of Example 1, the PS process is further promoted.

### Example 3

A cell was prepared with the same preparation method as that of Example 2, except that 37% by weight of liquid crystal molecules of trans-4-propyl-4′-vinyl-1,1′-bicyclohexane with respect to the total weight of the entire liquid crystal composition; and 1% by weight of biphenyl-4,4′diylbis(2-methyl acrylate), as the monomer, with respect to the total weight of the entire liquid crystal composition were added to 4-cyano-4′-pentylbiphenyl which was the positive type liquid crystal material. That is, in this example, as a liquid crystal component in the liquid crystal composition, mixed liquid crystal was used. When observed using a polarizing microscope, liquid crystal molecules were uniaxially aligned in a favorable manner. Furthermore, when liquid crystal was made to respond by applying a threshold or higher voltage thereto, the liquid crystal was aligned along zigzag-shaped comb electrodes and superior viewing characteristics were obtained by a multidomain structure. In addition, the image sticking ratio was only 3% when measured with the same method as that of Example 2. Therefore, according to Example 3, it was found that image stacking was further improved compared to Example 2.

The reaction systems (routes of generating acrylate radicals) of the PS process in Example 3 are as follows.

First, as illustrated in the following chemical reaction formula (24), trans-4-propyl-4′-vinyl-1,1′-bicyclohexane (compound represented by the following formula (23); hereinafter, referred to as “CC”) which is the liquid crystal material is excited by irradiation of ultraviolet rays.

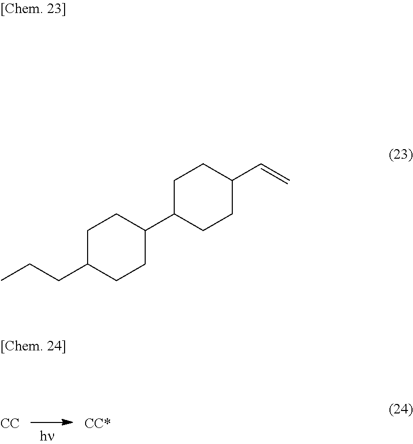 [SMILES: C=CC1CCC(C2CCC(CCC)CC2)CC1 ; "CC" ; "CC*"]

In addition, as illustrated in the following chemical reaction formula (25), biphenyl-4,4′-diylbis(2-methyl acrylate) which is the monomer is excited to form radicals by the energy transfer from excited trans-4-propyl-4′-vinyl-1,1′-bicyclohexane.

[Chem. 25]

M+CC*→M*+CC (25)

As illustrated in the chemical reaction formulae (24) and (25), when liquid crystal molecules having a multiple bond are used, image sticking is significantly improved by the PS process. In particular, when liquid crystal molecules having a double bond are used, the effect thereof is high. That is, trans-4-propyl-4′-vinyl-1,1′-bicyclohexane has higher efficiency of excitation using ultraviolet rays; and higher efficiency of energy transfer with the photoalignment films or liquid crystal molecules than those of 4-cyano-4′-pentylbiphenyl used in Examples 1 to 3. The difference in reactivity between two kinds of molecules is caused by whether the molecules have a triple bond of a cyano group or an alkenyl group. In the other words, a double bond has higher reaction efficiency than that of a triple bond.

### Example 4

An IPS liquid crystal cell was prepared with the same preparation method as that of Example 3, except that the time of the irradiation from a black light unit was set to be ⅙ that of Example 3; and the irradiation intensity was set to 350 mJ/cm². When observed using a polarizing microscope, liquid crystal molecules were uniaxially aligned in a favorable manner. Furthermore, when liquid crystal was made to respond by applying a threshold or higher voltage thereto, the liquid crystal was aligned along zigzag-shaped comb electrodes and superior viewing characteristics were obtained by a multidomain structure. In addition, the image sticking ratio was only 8% when measured with the same method as that of Example 2. Therefore, it was found that a sufficient image sticking prevention effect can be obtained even when the energy and time of ultraviolet ray irradiation are reduced in the PS process.

When Examples 1 to 4 described above are investigated, common advantageous effects of these examples are as follows.

In an actual usage configuration, in the case visible light is exposed (for example, a liquid crystal TV), visible light should be avoided as light used for an alignment treatment of a photoalignment film. However, in Examples 1 to 4, by performing the PS process, the surfaces of the photoalignment films are covered with the PS layers and the alignment is fixed. Therefore, there is an advantageous effect in that a material of which the sensitivity wavelength includes a visible light wavelength range may be used as the material of the photoalignment films.

In addition, when the sensitivity wavelength of the material of the photoalignment films includes a visible light wavelength range, it is necessary that an ultraviolet ray absorption layer be provided in order to cut weak ultraviolet rays emitted from a back light unit and the surrounding environment. In consideration of this point, there is an advantageous effect in that, by performing the PS process, it is not necessary that an ultraviolet ray absorption layer be provided.

In addition, when the PS process is performed using ultraviolet rays, there is a possibility that the voltage holding ratio (VHR) may deteriorate by liquid crystal being irradiated with ultraviolet rays. By efficiently performing the PS process as in the case of Examples 1 to 4, the ultraviolet ray irradiation time can be reduced and thus deterioration in voltage holding ratio can be avoided.

Furthermore, since image sticking is significantly improved, the irradiation amount for the PS process can also be reduced. When a liquid crystal panel is manufactured, the irradiation amount (time) is reduced and thus the throughput is increased. In addition, the size of an ultraviolet ray irradiation device can be reduced, which leads to a reduction in investment value.

### Example 5

A pair of glass substrates which include a transparent electrode, respectively, were prepared. A vertical alignment film material solution was coated on the respective substrates with a spin coating method. As a material of the transparent electrodes, ITO was used. The vertical alignment film material solution was prepared by dissolving 3% by weight of polyamic acid, having a cinnamate derivative in the molecules, in a solvent obtained by mixing the same amount of N-methyl-2-pyrollidone and ethylene glycol monobutyl ether.

After coating with a spin coating method, provisional drying was performed at 90° C. for 1 minute, followed by burning at 200° C. for 60 minutes while purging nitrogen gas. The thickness of the alignment films after burning was 60 nm.

Next, as an alignment treatment, the surface of each substrate was irradiated with linearly p-polarized ultraviolet rays having a wavelength of 313 nm and an intensity of 60 mJ/cm² from a direction tilted from the normal direction of each substrate by 40°.

Next, a thermosetting seal material (HC1413FP, manufactured by Mitsui Chemical Inc.) was printed on each of the electrode substrates using a screen plate. Furthermore, in order to obtain the liquid crystal layer having a thickness of 3.5 μm, beads (SP-2035, manufactured by Sekisui Chemical Co., Ltd.) having a diameter of 3.5 μm were dispersed on the counter substrate. These two kinds of substrates were aligned such that the polarization directions of ultraviolet rays irradiating the respective substrates become perpendicular to each other, and then were bonded.

Next, the bonded substrates were heated in a furnace in which nitrogen gas is purged at 110° C. for 60 minutes while applying a pressure of 0.5 kgf/cm² thereto, and thereby the seal material was cured.

A liquid crystal composition containing a liquid crystal material and a monomer was injected into a cell prepared with the above-described method under vacuum. As the liquid crystal material, a negative type liquid crystal which contains liquid crystal molecules having, as a double bond, only an ester group other than a benzene ring was used. As the monomer, biphenyl-4,4′-diylbis(2-methyl acrylate) was used. The amount of biphenyl-4,4′-diylbis(2-methyl acrylate) added is 0.3% by weight with respect to the total weight of the entire liquid crystal composition.

A filling port through which the liquid crystal composition was injected was blocked with an ultraviolet ray-curable resin (TB3026E, manufactured by ThreeBond Co., Ltd.) and was sealed by irradiation of ultraviolet rays. The wavelength of ultraviolet rays irradiated for sealing was 365 nm, and light was blocked in pixel portions so as to remove the influence of ultraviolet rays as much as possible. At this time, electrodes were short-circuited and the charge of a surface of the glass substrate was eliminated such that the alignment of liquid crystal was not disordered by outside electric field.

Next, in order to remove the flow alignment of liquid crystal molecules, a realignment treatment of heating the liquid crystal cell at 130° C. for 40 minutes to make the liquid crystal molecules have isotropic phase was performed. As a result, a vertical TN alignment liquid crystal cell having a pre-tilt angle of 89° was obtained.

Next, in order to subject this liquid crystal cell to the PS process, the liquid crystal cell was irradiated with non-polarized ultraviolet rays having an intensity of 16 J/cm² using a black light unit (FHF32BLB, manufactured by Toshiba Corporation). As a result, biphenyl-4,4′-diylbis(2-methyl acrylate) was polymerized.

The reaction systems (pathways of generating acrylate radicals) of the PS process in Example 5 are the same as those of Example 1.

With the above-described method, a vertical TN alignment cell (liquid crystal cell of Example 5) which was subjected to the PS process was prepared.

When observed using a polarizing microscope, liquid crystal molecules in the liquid crystal cell of Example 5 were vertically aligned in the TN mode, in a favorable manner as was before the PS process.

Next, the liquid crystal cell of Example 5 was evaluated for image sticking. An evaluation method for image sticking is as follows. The liquid crystal cell of Example 5 was divided into regions X and Y to which two different voltages can be applied. A square wave voltage of 7.5 V and 30 Hz was applied to the region X and no voltage was applied to the region Y for 48 hours. Next, a square wave voltage of 2.4 V and 30 Hz was applied to the regions X and Y, respectively. Then, the luminance T(x) of the region X and the luminance T(y) of the region Y were measured, respectively. A value ΔT(x,y) (%) which is the index of image sticking was calculated according to the following expression.

ΔT(x,y)=(|T(x)−T(y)|/T(y))×100

As a result of the calculation, the image sticking ratio ΔT of the liquid crystal cell of Example 5 was 30%.

### Comparative Example 3

A vertical TN alignment liquid crystal cell of Comparative Example 3 was prepared with the same preparation method as that of Example 5, except that the monomer was not added to the liquid crystal composition; and the liquid crystal layer was not irradiated with ultraviolet rays using a black light unit.

As a result, the image sticking ratio was 150% or higher, and severe image sticking was observed.

As seen from Example 5 and Comparative Example 3, when liquid crystal molecules contain an ester group, that is, a CO double bond, a given degree of improvement effect can be obtained. In addition, in the case of a vertical alignment film, it was found that the same degree of improvement effect as that of a horizontal alignment film cannot be obtained although severe image sticking caused by a material of a photoalignment film can be improved by performing the PS process without deterioration in alignment capability.

### Example 6

Example 6 is a preparation example of a liquid crystal cell of the FFS mode. A TFT substrate (hereinafter, also referred to as “FFS substrate”) that includes comb electrodes and a plate-like electrode (solid electrode) on a surface thereof; and a counter substrate having a color filter were prepared. A polyvinyl cinnamate solution which was a material of a horizontal alignment film was coated on the respective substrates with a spin coating method. As the glass, #1737 (manufactured by Corning Inc.) was used. As a material of the comb electrode, ITO was used. In addition, the shape of the comb electrodes was a zigzag shape, the width L of the comb electrodes was 5 μm, and the distance S between the electrodes was 5 μm. The polyvinyl cinnamate solution was prepared by dissolving 3% by weight of polyvinyl cinnamate with respect to the total weight in a solvent obtained by mixing the same amount of N-methyl-2-pyrollidone and ethylene glycol monobutyl ether.

After coating with a spin coating method, provisional drying was performed at 90° C. for 1 minute, followed by burning at 200° C. for 60 minutes while purging nitrogen gas. The thickness of the alignment films after burning was 100 nm.

Next, as an alignment treatment, the surface of each substrate was irradiated with linearly polarized ultraviolet rays having a wavelength of 313 nm and an intensity of 5 J/cm² from the normal direction of each substrate. At this time, an angle formed between the lengthwise direction of the comb electrodes and the polarization direction was set to 7°.

Next, a thermosetting seal material (HC1413EP, manufactured by Mitsui Chemical Inc.) was printed on the FFS substrate using a screen plate. Furthermore, in order to obtain the liquid crystal layer having a thickness of 3.5 μm, beads (SP-2035, manufactured by Sekisui Chemical Co., Ltd.) having a diameter of 3.5 μm were dispersed on the counter substrate. These two kinds of substrates were aligned such that the polarization directions of ultraviolet rays irradiating the respective substrates match with each other, and then were bonded.

Next, the bonded substrates were heated in a furnace in which nitrogen gas is purged at 110° C. for 60 minutes while applying a pressure of 0.5 kgf/cm² thereto, and thereby the seal material was cured.

A liquid crystal composition containing a liquid crystal material and a monomer was injected into a cell prepared with the above-described method under vacuum. In order to obtain the liquid crystal material, 37% by weight of trans-4-propyl-4′-vinyl-1,1′-bicyclohexane with respect to the total weight of the entire liquid crystal composition; and 1% by weight of biphenyl-4,4′diylbis(2-methyl acrylate), as the monomer, with respect to the total weight of the entire liquid crystal composition were added to 4-cyano-4′-pentylbiphenyl which was the positive type liquid crystal material. That is, in this example, as a liquid crystal component in the liquid crystal composition, mixed liquid crystal was used.

A filling port through which the liquid crystal composition was injected was blocked with an ultraviolet ray-curable resin (TB3026E, manufactured by ThreeBond Co., Ltd.) and was sealed by irradiation of ultraviolet rays. The wavelength of ultraviolet rays irradiated for sealing was 365 nm, and light was blocked in pixel portions so as to remove the influence of ultraviolet rays as much as possible. At this time, electrodes were short-circuited and the charge of a surface of the glass substrate was eliminated such that the alignment of liquid crystal was not disordered by outside electric field.

Next, in order to remove the flow alignment of liquid crystal molecules, a realignment treatment of heating the liquid panel cell at 130° C. for 40 minutes to make the liquid crystal molecules have isotropic phase was performed. As a result, a liquid crystal cell was obtained in which liquid crystal molecules were uniaxially aligned in the plane of the substrates in a direction perpendicular to the polarization direction of ultraviolet rays irradiating the alignment films.

Next, in order to simulate the bonding of substrates in the actual manufacturing process, the FFS panel was set such that an electrostatic chuck (manufactured by Tomoegawa Co., Ltd.) was in contact with the TFT substrate side. A voltage of 1.7 kV was applied to the electrostatic chuck, it was confirmed that a substrate was sufficiently held, and this state was maintained for 10 minutes.

Next, in order to subject this liquid crystal cell to the PS process, the liquid crystal cell was irradiated with non-polarized ultraviolet rays having an intensity of 2 J/cm² using a black light unit (FHF32BLB, manufactured by Toshiba Corporation). As a result, biphenyl-4,4′-diylbis(2-methyl acrylate) was polymerized.

Examples of a general bonding method which is currently used in the mass production process of a liquid crystal panel include one drop filling (ODF). One drop filling is a method in which a liquid crystal composition is added dropwise to one substrate and a pair of substrates are bonded to each other in a vacuum chamber. At this time, in order to efficiently hold an upper substrate in a vacuum, the electrostatic chuck was used. In a vacuum, vacuum holding cannot be used. The electrostatic chuck is a device that generates a high-voltage and holds a substrate using the electrostatic interaction. FIG. 7 is a diagram schematically illustrating a state in which a pair of substrates are bonded using an electrostatic chuck. As illustrated in FIG. 7, when an FFS substrate (array substrate) 80 and a counter substrate 90 are bonded, a high voltage is applied from an electrostatic chuck 101 to the FFS substrate 80 (arrows in the drawing indicate the direction of an electric field). The FFS substrate 80 has a structure in which an insulating film 82, a solid substrate (plate-like electrode) 83, an insulating film 84, and comb electrodes 85 are laminated on a glass substrate 81 in this order toward the liquid crystal layer side. The other substrate (counter substrate) 90 is arranged on a stage 102, and a liquid crystal composition 91 is added dropwise to a predetermined position on the counter substrate 90. An electric field generated from the electrostatic chuck 101 extends toward the liquid crystal layer (space between the pair of substrates 80 and 90) side. However, since there is a single layer of the solid electrode 83 on the FFS substrate 80, the electric field is blocked by the solid electrode 83. Accordingly, since the electric field is not applied to the liquid crystal layer and a photoalignment film, the alignment of liquid crystal is not disordered by the action of the electrostatic chuck 101 and thus image sticking can be prevented.

On the other hand, when an IPS substrate is used, a solid electrode is not provided on the IPS substrate and an electric field generated from an electrostatic chuck pass between comb electrodes. Therefore, there is a concern than the alignment of liquid crystal may be disordered to cause image stacking. In order to solve this problem, it is necessary that a post-treatment for removing image sticking be performed after bonding. Therefore, in consideration of use of an electrostatic chuck, the FFS substrate of Example 6 be preferably used compared to the IPS substrates of Examples 1 to 5.

When a panel was manufactured using the liquid crystal cell of Example 6, a liquid crystal display panel was obtained in which image stacking did not occur in liquid crystal display and liquid crystal molecules were uniformly arranged without unevenness.

Hereinafter, Examples 7 to 11 will be described. With these examples, the degree of image sticking which varied depending on the monomer concentration was examined.

### Example 7

A liquid crystal cell was prepared with the same preparation method as that of Example 1, except that 5% by weight of trans-4-propyl-4′-vinyl-1,1′-bicyclohexane, as the liquid crystal molecules having an alkenyl group, with respect to the total weight of the entire liquid crystal composition and 0.5% by weight of biphenyl-4,4′diylbis(2-methyl acrylate), as the monomer, with respect to the total weight of the entire liquid crystal composition were added to MLC-6610 (manufactured by Merck KGaA) which was the liquid crystal material; and the liquid crystal cell was irradiated with ultraviolet rays having an intensity of 600 mJ/cm² using a black light unit (FHF32BLB, manufactured by Toshiba Corporation). That is, in this example, as a liquid crystal component in the liquid crystal composition, mixed liquid crystal was used. When the alignment of liquid crystal molecules subjected to the PS process was observed through a pair of polarizing plates arranged in a cross Nichol configuration, the liquid crystal molecules were uniaxially aligned in a direction perpendicular to the polarization direction of ultraviolet rays. When measured with the same method as that of Example 1, the image sticking ratio ΔT was 6%. In addition, when image sticking was determined through an ND filter (transmittance: 10%), it was difficult to observe image sticking by visual inspection and image sticking was improved.

### Example 8

A liquid crystal cell was prepared with the same preparation method as that of Example 7, except that 0.3% by weight of biphenyl-4,4′diylbis(2-methyl acrylate), as the monomer, with respect to the total weight of the entire liquid crystal composition was added. When measured with the same method as that of Example 1, the image sticking ratio ΔT was 8%. In addition, when image sticking was determined through an ND filter (transmittance: 10%), it was difficult to observe image sticking by visual inspection and image sticking was improved.

### Example 9

A liquid crystal cell was prepared with the same preparation method as that of Example 7, except that 0.2% by weight of biphenyl-4,4′diylbis(2-methyl acrylate), as the monomer, with respect to the total weight of the entire liquid crystal composition was added. When measured with the same method as that of Example 1, the image sticking ratio ΔT was 9%. In addition, when image sticking was determined through an ND filter (transmittance: 10%), it was difficult to observe image sticking by visual inspection and image sticking was improved.

### Example 10

A liquid crystal cell was prepared with the same preparation method as that of Example 7, except that 0.15% by weight of biphenyl-4,4′diylbis(2-methyl acrylate), as the monomer, with respect to the total weight of the entire liquid crystal composition was added. When measured with the same method as that of Example 1, the image sticking ratio ΔT was 15%. In addition, when image sticking was determined through an ND filter (transmittance: 10%), it was difficult to observe image sticking by visual inspection and image sticking was improved.

### Example 11

A Liquid crystal cell was prepared with the same preparation method as that of Example 7, except that 0.1% by weight of biphenyl-4,4′diylbis(2-methyl acrylate), as the monomer, with respect to the total weight of the entire liquid crystal composition was added. When measured with the same method as that of Example 1, the image sticking ratio ΔT was 41%. In addition, when image sticking was determined through an ND filter (transmittance: 10%), image sticking was clearly observed compared to Examples 7 to 10.

Hereinafter, the evaluation results of Example 7 to 11 will be summarized. FIG. 8 is a graph illustrating the relationship between the monomer concentrations of Examples 7 to 11 and the image sticking ratio (ΔT). As illustrated in FIG. 8, the higher the monomer concentration, the less the image sticking ratio. In particular, when the monomer concentration is greater than or equal to 0.2% by weight, the reduction of the image sticking ratio is gentle. On the other hand, when the monomer concentration is less than or equal to 0.15% by weight, the image sticking ratio is rapidly increased. Assuming that a criterion for the effect of reducing image sticking is a ΔT value of 1.2, it was found that the superior effect of reducing image sticking can be obtained when the monomer concentration is at least greater than or equal to 0.15% by weight.

The liquid crystal cells of Examples 7 to 11 are different from those of Examples 1 to 6 in terms of the kind of the liquid crystal material, the kind of the monomer, and the like; but are similar to those of Examples 1 to 6 in terms of the relationship between the monomer concentration and the image sticking ratio. Therefore, the tendency of the evaluation results of Examples 7 to 11 can be applied to Examples 1 to 6.

Hereinafter, Examples 12 to 17 will be described. With these examples, the influence of the monomer concentration on the contrast ratio was examined.

### Example 12

Example 12 is a preparation example of a liquid crystal cell of the FFS mode. A TFT substrate (hereinafter, also referred to as “FFS substrate”) that includes slit-provided electrodes and a plate-like electrode (solid electrode) on a surface thereof; and a counter substrate having a color filter were prepared. A polyvinyl cinnamate solution which was a material of a horizontal alignment film was coated on the respective substrates with a spin coating method. The shape of the slit-provided electrodes was a zigzag shape, the distance L between slits was 5 μm, and the width S of a slit was 5 μm. For a semiconductor layer of TFT, an oxide semiconductor IGZO (indium gallium zinc oxide) was used. By using IGZO, a high transmittance can be obtained. The polyvinyl cinnamate solution was prepared by dissolving 3% by weight of polyvinyl cinnamate with respect to the total weight in a solvent obtained by mixing the same amount of N-methyl-2-pyrollidone and ethylene glycol monobutyl ether.

After coating with a spin coating method, provisional drying was performed at 90° C. for 1 minute, followed by burning at 200° C. for 60 minutes while purging nitrogen gas. The thickness of the alignment films after burning was 100 nm.

Next, as an alignment treatment, the surface of each substrate was irradiated with linearly polarized ultraviolet rays having a wavelength of 313 nm and an intensity of 5 J/cm² from the normal direction of each substrate. At this time, an angle formed between the lengthwise direction of the comb electrodes and the polarization direction was set to 10°.

Next, a thermosetting seal material (HC1413EP, manufactured by Mitsui Chemical Inc.) was printed on the FFS substrate using a screen plate. Furthermore, in order to obtain the liquid crystal layer having a thickness of 3.5 μm in a display region (active area), a photospacer was formed on the counter substrate. These two kinds of substrates were aligned such that the polarization directions of ultraviolet rays irradiating the respective substrates match with each other, and then were bonded.

Next, the bonded substrates were heated in a furnace in which nitrogen gas is purged at 110° C. for 60 minutes while applying a pressure of 0.5 kgf/cm² thereto, and thereby the seal material was cured.

A liquid crystal composition containing a liquid crystal material and a monomer was injected into a cell prepared with the above-described method under vacuum. In order to obtain the liquid crystal composition, 5% by weight of trans-4-propyl-4′-vinyl-1,1′-bicyclohexane, as the liquid crystal molecules having an alkenyl group, with respect to the total weight of the entire liquid crystal composition and 1% by weight of biphenyl-4,4′diylbis(2-methyl acrylate), as the monomer, with respect to the total weight of the entire liquid crystal composition were added to MLC-6610 (manufactured by Merck KGaA). That is, in this example, as a liquid crystal component in the liquid crystal composition, mixed liquid crystal was used.

A filling port through which the liquid crystal composition was injected was sealed with an epoxy adhesive (ARALDITE AR-S30, manufactured by Nichiban Co., Ltd.). At this time, electrodes were short-circuited and the charge of a surface of the glass substrate was eliminated such that the alignment of liquid crystal was not disordered by outside electric field.

Next, in order to simulate the bonding of substrates in the actual manufacturing process (ODF process), a realignment treatment of heating the liquid crystal panel at 130° C. for 40 minutes to make the liquid crystal molecules have isotropic phase was performed as a treatment for removing the flow alignment of liquid crystal molecules. As a result, liquid crystal molecules were uniaxially aligned in the plane of the substrates in a direction perpendicular to the polarization direction of ultraviolet rays irradiating the alignment films.

All the processes subsequent to the coating of the polyvinyl cinnamate solution were performed under yellow light such that the liquid crystal cell was not exposed to ultraviolet rays emitted from a fluorescent lamp. Next, in order to simulate the actual mass production environment, the liquid crystal cell was left to stand under a white fluorescent lamp (FHF32EXNH) for 10 minutes. The exposure amount of ultraviolet rays was only 0.4 mJ/cm². Furthermore, before the PS process, the liquid crystal cell was heated at 130° C. for 40 minutes, then a charge-eliminating process was performed elaborately.

Next, in order to subject this liquid crystal cell to the PS process, the liquid crystal cell was irradiated with non-polarized ultraviolet rays having an intensity of 2 J/cm² using a black light unit (FHF32BLB, manufactured by Toshiba Corporation). As a result, biphenyl-4,4′-diylbis(2-methyl acrylate) was polymerized. In this way, the liquid crystal cell of Example 12 was prepared.

When a pixel region was observed using a microscope, it was found that, although liquid crystal molecules were uniaxially aligned, the pixel region is rough; and a polymer was formed in a cluster.

Next, this liquid crystal cell was held between a pair of polarizing plates arranged in a cross Nichol configuration, the transmission axis of one polarizing plate was made to match with the alignment axis of liquid crystal, and the contrast evaluation was performed. The luminance was measured using a luminance meter SR-UL2 (manufactured by Topcon Technohouse Corporation) and the contrast ratio was calculated based on the following expression.

CR=Tmax/Tmin

In this expression, Tmax represents the maximum luminance when a voltage is applied; and Tmin represents the luminance when no voltage is applied. As a result of the measurement, the contrast ratio of the liquid crystal cell of Example 12 was 920.

### Example 13

A liquid crystal cell was prepared with the same preparation method as that of Example 12, except that 0.8% by weight of biphenyl-4,4′diylbis(2-methyl acrylate), as the monomer, with respect to the total weight of the entire liquid crystal composition was added. When measured with the same method as that of Example 12, the contrast ratio was 960.

### Example 14

A liquid crystal cell was prepared with the same preparation method as that of Example 12, except that 0.6% by weight of biphenyl-4,4′diylbis(2-methyl acrylate), as the monomer, with respect to the total weight of the entire liquid crystal composition was added. When measured with the same method as that of Example 12, the contrast ratio was 1030.

### Example 15

A liquid crystal cell was prepared with the same preparation method as that of Example 12, except that 0.5% by weight of biphenyl-4,4′diylbis(2-methyl acrylate), as the monomer, with respect to the total weight of the entire liquid crystal composition was added. When measured with the same method as that of Example 12, the contrast ratio was 1050.

### Example 16

A liquid crystal cell was prepared with the same preparation method as that of Example 12, except that 0.3% by weight of biphenyl-4,4′diylbis(2-methyl acrylate), as the monomer, with respect to the total weight of the entire liquid crystal composition was added. When measured with the same method as that of Example 12, the contrast ratio was 1120.

### Example 17

A liquid crystal cell was prepared with the same preparation method as that of Example 12, except that 0.15% by weight of biphenyl-4,4′diylbis(2-methyl acrylate), as the monomer, with respect to the total weight of the entire liquid crystal composition was added. When measured with the same method as that of Example 12, the contrast ratio was 1200.

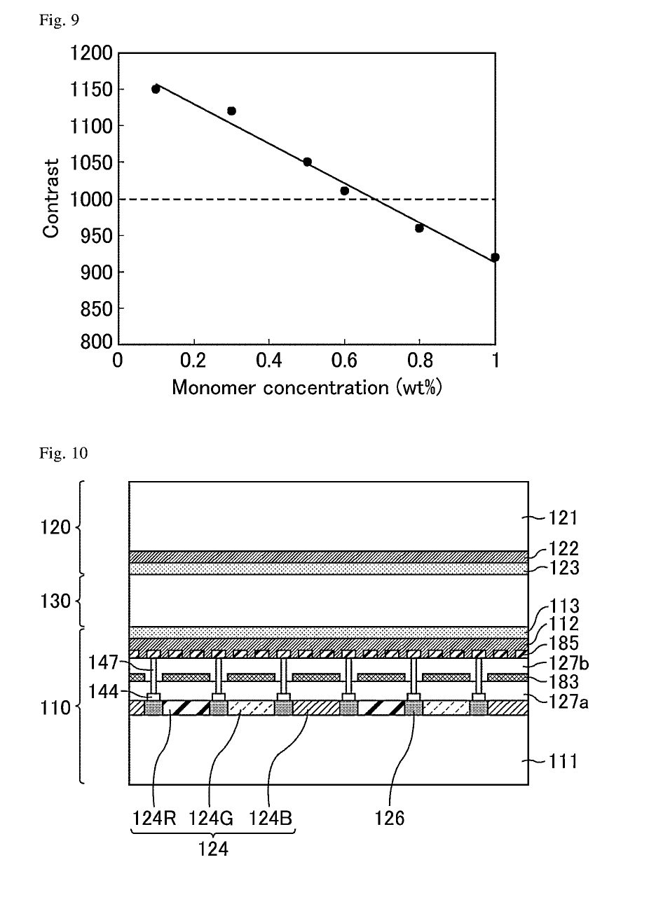

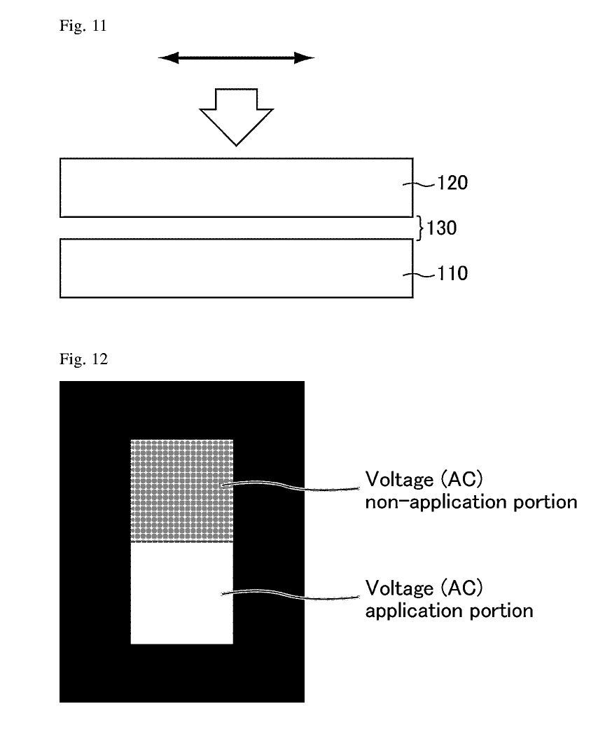

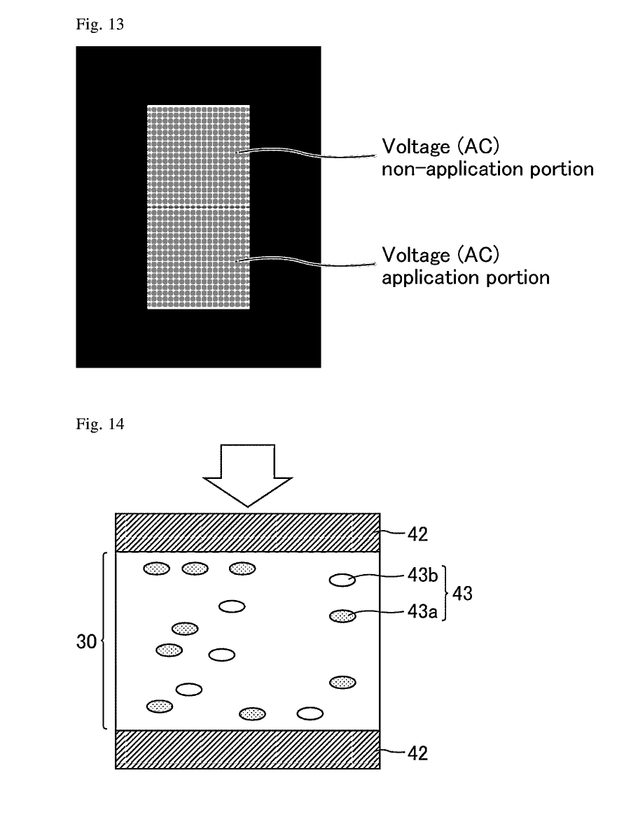

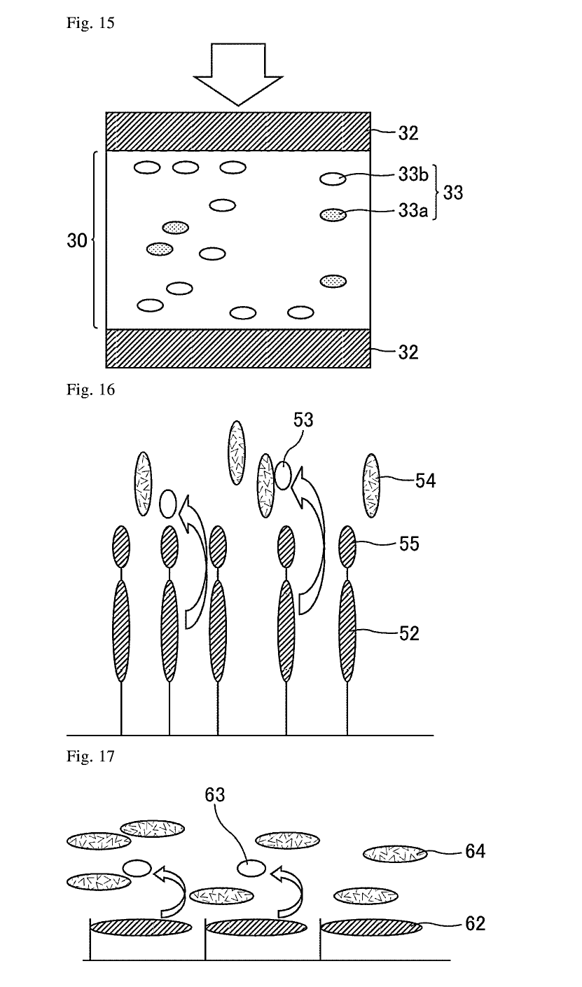

Hereinafter, the evaluation results of Example 12 to 17 will be summarized. FIG. 9 is a graph illustrating the relationship between the monomer concentrations of Examples 12 to 17 and the contrast ratio. As illustrated in FIG. 9, the higher the monomer concentration, the less the contrast ratio. In practice, when the monomer concentration was reduced, the number of luminous dots is reduced and the roughness of black display was also improved. That is, it was found that, when the monomer concentration is reduced, there are no special changes in white luminance; and a liquid crystal cell having superior performance of low gray-scale display. Assuming that a criterion for the contrast evaluation is 1000, it was found that the high contrast ratio can be obtained when the monomer concentration is at least less than or equal to 0.6% by weight.

The liquid crystal cells of Examples 12 to 17 are different from those of Examples 1 to 11 in terms of the kind of the liquid crystal material, the kind of the monomer, and the like; but are similar to those of Examples 1 to 11 in terms of the relationship between the monomer concentration and the contrast ratio. Therefore, the tendency of the evaluation results of Examples 12 to 17 can be applied to Examples 1 to 11.

Hereinafter, the irradiation of linearly polarized ultraviolet rays for the photoalignment treatment of Examples 1 to 17 was performed before the bonding of the pair of substrates. However, the photoalignment treatment may be performed from the outside of the liquid crystal cell after the bonding of the pair of substrates. The photoalignment treatment may be performed before or after liquid crystal filling. However, when the irradiation of linearly polarized ultraviolet rays for the photoalignment treatment is performed after liquid crystal filling, the photoalignment treatment and the PS process can be simultaneously performed. In this case, it is necessary that the time required for the photoalignment treatment be shorter than the irradiation time of ultraviolet rays required for the PS process. If the time required for the photoalignment treatment is longer than or equal to the irradiation time of ultraviolet rays required for the PS process, liquid crystal is not aligned.

Hereinafter, examples will be described in which the irradiation of linearly polarized ultraviolet rays for the photoalignment treatment is actually performed after the bonding of the pair of substrates.

### Example 18

Example 18 is a preparation example of a liquid crystal cell of the FFS mode. A TFT substrate (FFS substrate) that includes slit-provided electrodes and a plate-like electrode (solid electrode) on a surface thereof; and a counter substrate having a color filter were prepared. A polyvinyl cinnamate solution which was a material of a horizontal alignment film was coated on the respective substrates with a spin coating method. The size of the FFS substrate was 10 inch. The shape of the slit-provided electrodes was a zigzag shape, the distance L between slits was 3 μm, and the width S of a slit was 5 μm. For a semiconductor layer of TFT, an oxide semiconductor IGZO (indium gallium zinc oxide) was used. The polyvinyl cinnamate solution was prepared by dissolving 3% by weight of polyvinyl cinnamate with respect to the total weight in a solvent obtained by mixing the same amount of N-methyl-2-pyrollidone and ethylene glycol monobutyl ether.

After coating with a spin coating method, provisional drying was performed at 100° C. for 1 minute, followed by burning at 220° C. for 40 minutes while purging nitrogen gas. The thickness of the alignment films after burning was 75 nm on the comb electrodes of a display region (active area) of the FFS substrate. The thickness was 85 nm in a display region (active area) of the color filter substrate.

Next, a seal material for heat and ultraviolet rays (PHOTOLEC S-WB, manufactured by Sekisui Chemical Co., Ltd.) was printed on the FFS substrate using a dispenser. At this time, a printing pattern was formed so as to form a filling port for subsequent vacuum injection. Furthermore, in order to obtain the liquid crystal layer having a thickness of 3.5 μm in a display region (active area), a photospacer was formed on the counter substrate. The bottom diameter of the photospacer was 12 μm. The bottom diameter refers to the diameter of a portion in contact with a layer immediately below an alignment film. These two kinds of substrates were aligned and then were bonded.

Next, the seal material was cured using an ultra-high pressure mercury lamp (USH-500D, manufactured by Ushio Inc.) while applying a pressure of 0.5 kgf/cm² to the bonded substrates. Then, heating was performed for 40 minutes at 130° C. while applying a pressure to thermally cure the seal material.

Next, as an alignment treatment, the surface of each substrate was irradiated with linearly polarized ultraviolet rays having a wavelength of 313 nm and an intensity of 60 J/cm² from the normal direction by using the array substrate as an irradiation surface. At this time, an angle formed between the lengthwise direction of the comb electrodes and the polarization direction was set to 10°.

A liquid crystal composition containing a liquid crystal material and a monomer was injected into a cell prepared with the above-described method under vacuum. In order to obtain the liquid crystal composition, 5% by weight of trans-4-propyl-4′-vinyl-1,1′-bicyclohexane, as the liquid crystal molecules having an alkenyl group, with respect to the total weight of the entire liquid crystal composition and 1% by weight of biphenyl-4,4′diylbis(2-methyl acrylate), as the monomer, with respect to the total weight of the entire liquid crystal composition were added to MLC-6610 (manufactured by Merck KGaA). That is, in this example, as a liquid crystal component in the liquid crystal composition, mixed liquid crystal was used.

A filling port through which the liquid crystal composition was injected was sealed with an epoxy adhesive (ARALDITE AR-S30, manufactured by Nichiban Co., Ltd.). At this time, electrodes were short-circuited and the charge of a surface of the glass substrate was eliminated such that the alignment of liquid crystal was not disordered by outside electric field.

Next, a realignment treatment of heating the liquid crystal panel at 130° C. for 40 minutes to make the liquid crystal molecules have isotropic phase was performed as a treatment for removing the flow alignment of liquid crystal molecules. As a result, liquid crystal molecules were uniaxially aligned in the plane of the substrates in a direction perpendicular to the polarization direction of ultraviolet rays irradiating the alignment films.

All the processes subsequent to the coating of the polyvinyl cinnamate solution were performed under yellow light such that the liquid crystal cell was not exposed to ultraviolet rays emitted from a fluorescent lamp. Furthermore, before the PS process, the liquid crystal cell was heated at 130° C. for 40 minutes, then a charge-eliminating process was performed.

Next, in order to subject this liquid crystal cell to the PS process, the liquid crystal cell was irradiated with non-polarized ultraviolet rays having an intensity of 1.5 J/cm² using a black light unit (FHF32BLB, manufactured by Toshiba Corporation). As a result, biphenyl-4,4′-diylbis(2-methyl acrylate) was polymerized. In this way, the liquid crystal cell of Example 18 was prepared.

A liquid crystal display panel was manufactured using this liquid crystal cell. When the display thereof was visually inspected, superior display having no alignment non-uniformity and a small amount of image sticking was obtained.

### Example 19

A liquid crystal cell of Example 19 was prepared with the same preparation method as that of Example 13, except that an ultra-high pressure mercury lamp (USH-500D, manufactured by Ushio Inc.) was used instead of a black light unit as the light source of the PS process; a polarizer was set between the light source and the liquid crystal cell; and the liquid crystal layer was irradiated with linearly polarized ultraviolet rays from the normal direction of each substrate. The polarization direction refers to the direction perpendicular to the alignment direction of liquid crystal molecules in the plate of a panel. The irradiation amount was 1.5 J/cm². When measured with the same method as that of Example 12, the contrast ratio was 1100. As compared to Example 13, an effect of improving the contrast ratio was obtained.

### Example 20

A FFS liquid crystal panel was prepared with the same preparation method as that of Example 6, except that a polyimide solution having a cyclobutane skeleton was used as the photoalignment film material; and as an alignment treatment, the surface of each substrate was irradiated with polarized ultraviolet rays having a wavelength of 254 nm and an intensity of 500 J/cm² from the normal direction of each substrate. As a result, the alignment film material coated on the substrates caused photodegradation, and horizontal alignment films were formed.

As a result of evaluating the performance of this liquid crystal panel, an increase in drive voltage, deterioration in contrast ratio, and significant deterioration in voltage holding ratio were not observed compared to Example 6. Further, a particular improvement effect for image sticking was obtained.

### Comparative Example 4

A liquid crystal display device of the FFS mode was prepared with the same preparation method as that of Example 20, except that the monomer was not added to the liquid crystal material, thereby the PS polymerization was not performed.

As a result of evaluating the performance of this liquid crystal panel, it was found that sufficient alignment properties were not obtained. The reason is presumed to be that the photodegradation of the alignment film material was not sufficient. In order to form an alignment film having sufficient alignment properties from the alignment film material having a cyclobutane skeleton without performing the PSA polymerization, it is considered that the irradiation of ultraviolet rays have an intensity of approximately 2 J/cm². However, in this case, photodegradation occurs in the other components of the alignment film or a color filter, which may impair the long-period reliability. On the other hand, in the liquid crystal panel of Example 20, it was found that, due to the action of the PS layer, sufficient alignment properties can be obtained by the irradiation of ultraviolet rays having an intensity which does not impair the long-period reliability.

### Embodiment 2

In Embodiment 1, the configuration has been described in which color filters are arranged on the counter substrate. In Embodiment 2, a configuration will be described in which color filters and black matrixes are formed on the array substrate side; and the counter substrate is a blank substrate.

The configuration of a liquid crystal display device according to Embodiment 2 is the same as that of Embodiment 1, except that a color filter on array (COA) structure is adopted in which color filters are formed on the array substrate; and a black matrix on array (BOA) structure is adopted in which black matrixes are formed on the array substrate. That is, in Embodiment 2, the same characteristics as those of Examples 1 to 20 can be adopted, and the evaluation results having the same tendencies are obtained. Hereinafter, the description will be made using a liquid crystal display device of the FFS mode as an example.

FIG. 10 is a cross-sectional view schematically illustrating the liquid crystal display device according to Embodiment 2. As illustrated in FIG. 10, in Embodiment 2, color filters 124 and black matrixes 126 are formed on an array substrate 110. More specifically, the color filters 124 and the black matrixes 126 are arranged between a transparent substrate 111 formed of glass or the like and an interlayer dielectric film 127a. Plate-like common electrodes 183 are arranged on the insulating dielectric film 127a, and slit-provided pixel electrodes 185 are arranged on the common electrodes 183 with the interlayer dielectric film 127b interposed therebetween. In addition, TFTs 144 are formed between the transparent substrate 111 and the color filters 124. The pixel electrodes 185 are connected to the TFTs 144 through the color filters 124 and contact portions 147 which are formed in the interlayer dielectric films 127a and 127b. The interlayer dielectric films 127a and 127b also serve to planarize convex and concave portions generated by the color filters 124. The interlayer dielectric films 127a and 127b are formed of, for example, a photosensitive acrylate resin, a photosensitive polyimide resin, or the like. The thickness of the interlayer dielectric films 127a and 127b is preferably greater than or equal to 1 μm. The common electrodes 183 and the pixel electrodes 185 are transparent electrodes.

The liquid crystal display device according to Embodiment 2 includes alignment films 112 and 122 on the pixel electrodes 185 and the transparent substrate 121. Through the PS polymerization process, the polymerization of polymerizable monomers starts. As illustrated in FIG. 10, PS layers 113 and 123 are formed on the alignment films 112 and 122, and thus the alignment regulating force of the alignment films 112 and 122 is stabilized.

In FIG. 10, three color filters including a red filter 124R, a green filter 124G, and a blue filter 124B are used. However, the kind, number, and arrangement order of color filters are not particularly limited.

FIG. 11 is a diagram schematically illustrating a light irradiation state when the PS polymerization process is performed in Embodiment 2. In FIG. 11, a double-headed arrow indicates an alignment direction of liquid crystal molecules, and a thick arrow indicates an irradiation direction of light. In Embodiment 2, unlike Embodiment 1, it is preferable that a liquid crystal layer 130 be irradiated with light from the side of a counter substrate 120. As a result, light is not shielded by the color filters, the black matrixes, or the like. Therefore, a high transmittance can be obtained and the polymerization rate can be improved. Furthermore, since a shadow is not formed, the possibility of alignment defects can be reduced. In addition, a polymer can be formed without unevenness and a PS layer having a uniform thickness can be formed. Therefore, the roughness of display can be prevented. Furthermore, the irradiation time of ultraviolet rays can be further reduced, which leads to a reduction in image sticking.

### Embodiment 3

In Embodiment 3, a method for manufacturing a liquid crystal display device in which linearly polarized light is used for the PS process will be described in more detail. Components of a liquid crystal display device which is manufactured using the manufacturing method according to Embodiment 3 are the same as those of Embodiments 1 and 2. Hereinafter, examples in which linearly polarized light was used for the PS process will be described. Before the description of the examples, a reference example which is a criterion for the evaluation will be described first.

### Reference Example

This reference example is a preparation example of a liquid crystal cell of the FFS mode. A TFT substrate (FFS substrate) that includes comb electrodes and a plate-like electrode (solid electrode) on a surface thereof; and a counter substrate having a color filter were prepared. A polyvinyl cinnamate solution which was a material of a horizontal alignment film was coated on the respective substrates with a spin coating method. The shape of the comb electrodes was a zigzag shape, the width L of the comb electrodes was 3 μm, and the distance S between the electrodes was 5 μm. For a semiconductor layer of TFT, an oxide semiconductor IGZO (indium gallium zinc oxide) was used. By using IGZO, a high transmittance can be obtained. The polyvinyl cinnamate solution was prepared by dissolving 3% by weight of polyvinyl cinnamate with respect to the total weight in a solvent obtained by mixing the same amount of N-methyl-2-pyrollidone and ethylene glycol monobutyl ether.

After coating with a spin coating method, provisional drying was performed at 90° C. for 1 minute, followed by burning at 200° C. for 60 minutes while purging nitrogen gas. The thickness of the alignment films after burning was 100 nm.

Next, as an alignment treatment, the surface of each substrate was irradiated with linearly polarized ultraviolet rays having a wavelength of 313 nm and an intensity of 5 J/cm² from the normal direction of each substrate. At this time, an angle formed between the lengthwise direction of the slit-provided electrodes and the polarization direction was set to 10°.

Next, a thermosetting seal material (HC1413EP, manufactured by Mitsui Chemical Inc.) was printed on the FFS substrate using a screen plate. Furthermore, in order to obtain the liquid crystal layer having a thickness of 3.5 μm in a display region (active area), a photospacer was formed on the counter substrate. These two kinds of substrates were aligned such that the polarization directions of ultraviolet rays irradiating the respective substrates match with each other, and then were bonded.

Next, the bonded substrates were heated in a furnace in which nitrogen gas is purged at 110° C. for 60 minutes while applying a pressure of 0.5 kgf/cm² thereto, and thereby the seal material was cured.

A liquid crystal composition containing a liquid crystal material and a monomer was injected into a cell prepared with the above-described method under vacuum. In order to obtain the liquid crystal composition, 5% by weight of trans-4-propyl-4′-vinyl-1,1′-bicyclohexane, as the liquid crystal molecules having an alkenyl group, with respect to the total weight of the entire liquid crystal composition and 1% by weight of biphenyl-4,4′diylbis(2-methyl acrylate), as the monomer, with respect to the total weight of the entire liquid crystal composition were added to MLC-6610 (manufactured by Merck KGaA). That is, in this reference example, as a liquid crystal component in the liquid crystal composition, mixed liquid crystal was used.

A filling port through which the liquid crystal composition was injected was sealed with an epoxy adhesive (ARALDITEAR-S30, manufactured by Nichiban Co., Ltd.). At this time, electrodes were short-circuited and the charge of a surface of the glass substrate was eliminated such that the alignment of liquid crystal was not disordered by outside electric field.

Next, in order to simulate the bonding of substrates in the actual manufacturing process (ODF process), a realignment treatment of heating the liquid crystal panel at 130° C. for 40 minutes to make the liquid crystal molecules have isotropic phase was performed as a treatment for removing the flow alignment of liquid crystal molecules. As a result, liquid crystal molecules were uniaxially aligned in the plane of the substrates in a direction perpendicular to the polarization direction of ultraviolet rays irradiating the alignment films.

All the processes subsequent to the coating of the polyvinyl cinnamate solution were performed under yellow light such that the liquid crystal cell was not exposed to ultraviolet rays emitted from a fluorescent lamp. This liquid crystal cell was held between a pair of polarizing plates arranged in a cross Nichol configuration, the transmission axis of one polarizing plate was made to match with the alignment axis of liquid crystal, and the liquid crystal cell before the PS process was evaluated for luminance in black display. The luminance was measured using a photomultiplier (manufactured by Hamamatsu Photonics K K)

Next, in order to subject this liquid crystal cell to the PS process, the liquid crystal cell was irradiated with non-polarized ultraviolet rays having an intensity of 2 J/cm² using a black light unit (FHF32BLB, manufactured by Toshiba Corporation). As a result, biphenyl-4,4′-diylbis(2-methyl acrylate) was polymerized. The polarized ultraviolet rays used for the photoalignment films and the polarized ultraviolet rays used for the PS process have different properties normally, for example, have different dominant wavelengths.

In this way, a liquid crystal cell of Reference Example was prepared. This liquid crystal cell was evaluated for the luminance in black display with the same method performed before the PS process. After the PS process, the luminance in black display was increased by 14% and the contrast ratio was reduced by 14% compared to before the PS process.

### Example 21

A liquid crystal cell of the FFS mode was prepared with the same preparation method as that of Reference Example, except that an ultra-high pressure mercury lamp (USH-500D, manufactured by Ushio Inc.) was used instead of a black light unit as the light source of the PS process; a polarizer was set between the light source and the liquid crystal cell; and the liquid crystal layer was irradiated with linearly polarized ultraviolet rays from the normal direction of each substrate. The polarization direction of the linearly polarized ultraviolet rays was perpendicular to the alignment direction of liquid crystal molecules. The polarization degree was 10:1 at 313 nm. The irradiation amount was 1.5 J/cm². The luminance in black display was evaluation with the same method as that of Reference Example. After the PS process, the luminance in black display was reduced by 10% and the contrast ratio was increased by 10% compared to before the PS process.

### Example 22

A FFS liquid crystal panel was prepared with the same preparation method as that of Example 21, except that a polyimide solution having a cyclobutane skeleton was used as the photoalignment film material; and as a photoalignment treatment, the surface of each substrate was irradiated with polarized ultraviolet rays having a wavelength of 254 nm and an intensity of 1.5 J/cm² from the normal direction of each substrate. As a result, the alignment film material coated on the substrates caused photodegradation, and horizontal alignment films were formed. The luminance in black display was evaluation with the same method as that of Reference Example. After the PS process, the luminance in black display was increased by 5% and the contrast ratio was reduced by 5% compared to before the PS process. However, the reduction in contrast ratio was suppressed compared to Reference Example.

### Example 23

A liquid crystal cell of the IPS mode was prepared with the same preparation method as that of Example 21, except that an IPS substrate was used instead of the FFS substrate as one substrate; and a blank glass substrate was used instead of the color filter substrate as the other substrate. The width L of the comb electrodes was 3 μm, and the distance S between the electrodes was 9 μm. The luminance in black display was evaluation with the same method as that of Reference Example. After the PS process, the luminance in black display was reduced by 10% and the contrast ratio was increased by 10% compared to before the PS process.

### Example 24

A liquid crystal cell of the FFS mode was prepared with the same preparation method as that of Example 21, except that the polarization direction was shifted by 85° with respect to the alignment direction of liquid crystal molecules in order to examine the margin of the polarization direction of linearly polarized light used for the PS process. After the PS process, the luminance in black display was increased by 10% and the contrast ratio was reduced by 10% compared to before the PS process. However, the reduction in contrast ratio was suppressed compared to Reference Example. Based on the above results, it was found that it is preferable that the linearly polarized light with which the monomer is irradiated has a polarization direction within a range of at most ±5° with respect to a direction substantially perpendicular to an alignment direction of liquid crystal molecules in the liquid crystal composition.

The present application claims priority to Patent Application Nos. 2010-231924 filed in Japan on Oct. 14, 2010, 2011-84755 filed in Japan on Apr. 6, 2011, and 2011-183796 filed in Japan on Aug. 25, 2011 under the Paris Convention and provisions of national law in a designated State, the entire contents of which are hereby incorporated by reference.

### REFERENCE TO DEPOSITED BIOLOGICAL MATERIAL

3, 33, 43, 53, 63: polymerizable monomer
10, 110: array substrate
11, 21, 111, 121: transparent substrate
12, 22, 32, 42, 112, 122: alignment film (undercoat film)
13, 23, 113, 123: PS layer (polymer layer)
14, 72: signal electrode
15, 71: common electrode
33a, 43a: polymerizable monomer (non-excited)
33b, 43b: polymerizable monomer (excited state)
20: color filter substrate
24, 124: color filter
26, 126: black matrix
27: overcoat layer (planarizing layer)
30, 130: liquid crystal layer
52: photoactive layer (vertical alignment film molecules)
54, 64, 74: liquid crystal molecules
55: hydrophobic layer
62: photoactive group (horizontal alignment film molecules)
80: FFS substrate (array substrate)
81: glass substrate
82, 84: insulating film
83: solid electrode (plate-like electrode)
85: comb electrode
90, 120: counter substrate
91: liquid crystal composition
101: electrostatic chuck
102: stage
124R: red color filter
124G: green color filter
124B: blue color filter
127a, 127b: interlayer dielectric film (planarizing film)
144: TFT
147: contact portion
183: common electrode
185: pixel electrode

1. A liquid crystal display device comprising:
a liquid crystal cell that includes a pair of substrates and a liquid crystal layer which is held between the pair of substrates,
wherein at least one substrate of the pair of substrates includes an electrode, an undercoat film which is formed on a liquid crystal layer side of the electrode, and a polymer layer which is formed on a liquid crystal layer side of the undercoat film and controls the alignment of liquid crystal molecules adjacent to the polymer layer,
the undercoat film is formed of a photoactive material,
the polymer layer is formed by polymerization of a monomer added to the liquid crystal layer, and
the liquid crystal layer contains liquid crystal molecules having, in a molecular structure thereof, a multiple bond other than conjugated double bonds of a benzene ring.

2. The liquid crystal display device according to claim 1,
wherein a polymerizable functional group of the monomer is an acrylate group, a methacrylate group, a vinyl group, a vinyloxy group, or an epoxy group.

3. The liquid crystal display device according to claim 1 or 2,
wherein the photoactive material is a photoalignment film material.

4. The liquid crystal display device according to claim 3,
wherein the photoalignment film material contains a compound having a cyclobutane skeleton.

5. The liquid crystal display device according to claim 3,
wherein the photoalignment film material contains a compound having either or both of a photoisomerizable functional group and a photodimerizable functional group.

6. The liquid crystal display device according to claim 5,
wherein the photoisomerizable functional group or the photodimerizable functional group is a cinnamate group or a derivative thereof.

7. The liquid crystal display device according to any one of claims 1 to 6,
wherein the undercoat film is a horizontal alignment film which aligns liquid crystal molecules adjacent to the horizontal alignment film substantially parallel to a surface of the undercoat film.

8. The liquid crystal display device according to any one of claims 1 to 7,
wherein the undercoat film is a photoalignment film which is subjected to a photoalignment treatment by either or both of ultraviolet rays and visible light rays.

9. The liquid crystal display device according to any one of claims 1 to 8,
wherein the undercoat film is a photoalignment film which is subjected to a photoalignment treatment by non-polarized light or linearly polarized light.

10. The liquid crystal display device according to any one of claims 1 to 9,
wherein the multiple bond is a double bond.

11. The liquid crystal display device according to claim 10,
wherein the double bond is contained in an ester group.

12. The liquid crystal display device according to claim 10,
wherein the double bond is contained in an alkenyl group.

13. The liquid crystal display device according to any one of claims 1 to 9,
wherein the multiple bond is a triple bond.

14. The liquid crystal display device according to claim 13,
wherein the triple bond is contained in a cyano group.

15. The liquid crystal display device according to any one of claims 1 to 14,
wherein the liquid crystal molecules contain two or more kinds of multiple bonds.

16. The liquid crystal display device according to any one of claims 1 to 15,
wherein a concentration of the monomer, added to the liquid crystal layer, in the entire composition constituting the liquid crystal layer before polymerization is greater than or equal to 0.15% by weight.

17. The liquid crystal display device according to any one of claims 1 to 16,
wherein a concentration of the monomer, added to the liquid crystal layer, in the entire composition constituting the liquid crystal layer before polymerization is less than or equal to 0.6% by weight.

18. The liquid crystal display device according to any one of claims 1 to 17,
wherein the polymer layer is formed by thermal polymerization.

19. The liquid crystal display device according to any one of claims 1 to 17,
wherein the polymer layer is formed by photopolymerization.

20. The liquid crystal display device according to claim 19,
wherein light used for the photopolymerization is either or both of ultraviolet rays and visible light rays.

21. The liquid crystal display device according to claim 20,
wherein light used for the photopolymerization is linearly polarized light or non-polarized light.

22. The liquid crystal display device according to any one of claims 1 to 21,
wherein the number of polymerizable functional groups included in the monomer is more than or equal to 2.

23. The liquid crystal display device according to any one of claims 1 to 22,
wherein the number of polymerizable functional groups included in the monomer is more than or equal to 4.

24. The liquid crystal display device according to any one of claims 1 to 7 and 10 to 23,
wherein the undercoat film is an alignment layer which is subjected to an alignment treatment other than a photoalignment treatment.

25. The liquid crystal display device according to any one of claims 1 to 6 and 10 to 23,
wherein the undercoat film is not subjected to an alignment treatment.

26. The liquid crystal display device according to any one of claims 1 to 23,
wherein the undercoat film is a photoalignment film which is subjected to a photoalignment treatment by irradiation of ultraviolet rays emitted from the outside of the liquid crystal cell.

27. The liquid crystal display device according to any one of claims 1 to 26,
wherein the electrode is a transparent electrode.

28. The liquid crystal display device according to any one of claims 1 to 27,
wherein at least one substrate of the pair of substrates further includes a planarizing film which planarizes a substrate surface.

29. The liquid crystal display device according to any one of claims 1 to 28,
wherein an alignment mode of the liquid crystal layer is the IPS mode, the FLC mode, the PDLC mode, or the blue phase mode.

30. The liquid crystal display device according to any one of claims 1 to 28,
wherein an alignment mode of the liquid crystal layer is the FFS mode.

31. The liquid crystal display device according to any one of claims 1 to 28,
wherein an alignment mode of the liquid crystal layer is the OCB mode, the TN mode, or the STN mode.

32. The liquid crystal display device according to any one of claims 29 to 31,
wherein at least one substrate of the pair of substrates has a multidomain structure.

33. A method for manufacturing a liquid crystal display device comprising:
a step of forming a horizontal alignment film on at least one substrate of a pair of substrates;
a step of filing a gap between the pair of substrates with a liquid crystal composition containing a monomer; and
a step of irradiating the monomer with light to form a polymer layer on the horizontal alignment film,
wherein the monomer is irradiated with linearly polarized light.

34. The method for manufacturing a liquid crystal display device according to claim 33,
wherein the linearly polarized light with which the monomer is irradiated has a polarization direction substantially perpendicular to an alignment direction of liquid crystal molecules in the liquid crystal composition.

35. The method for manufacturing a liquid crystal display device according to claim 33 or 34,
wherein the step of forming a horizontal alignment film includes a step of subjecting a photoalignment film material to a photoalignment treatment.

36. The method for manufacturing a liquid crystal display device according to claim 35,
wherein the photoalignment treatment is performed using linearly polarized light, and
a polarization direction of the linearly polarized light with which the monomer is irradiated substantially matches with a polarization direction of linearly polarized light used for the photoalignment treatment.

37. The method for manufacturing a liquid crystal display device according to claim 35 or 36,
wherein the photoalignment film material contains a compound having a cyclobutane skeleton.

38. The method for manufacturing a liquid crystal display device according to claim 35 or 36,
wherein the photoalignment film material contains a compound having either or both of a photoisomerizable functional group and a photodimerizable functional group.

39. The method for manufacturing a liquid crystal display device according to claim 38,
wherein the photoisomerizable functional group or the photodimerizable functional group is a cinnamate group or a derivative thereof.

40. The method for manufacturing a liquid crystal display device according to any one of claims 33 to 39,
wherein the liquid crystal composition contains liquid crystal molecules having, in a molecular structure thereof, a multiple bond other than conjugated double bonds of a benzene ring.

41. The method for manufacturing a liquid crystal display device according to claim 40,
wherein the multiple bond is a double bond.

42. The method for manufacturing a liquid crystal display device according to claim 41,
wherein the double bond is contained in an alkenyl group.

43. The method for manufacturing a liquid crystal display device according to any one of claims 33 to 42,
wherein an alignment mode of the liquid crystal display device is the IPS mode.

44. The method for manufacturing a liquid crystal display device according to any one of claims 33 to 42,
wherein an alignment mode of the liquid crystal display device is the FFS mode.

45. The method for manufacturing a liquid crystal display device according to any one of claims 33 to 44,
wherein a polymerizable functional group of the monomer contains at least one of an acrylate group and a methacrylate group.
